(19) United States
(12) Patent Application Publication
(10) Pub. No.: US 2016/0328692 A1
(43) Pub. Date: Nov. 10, 2016

(54) MOBILE CASH CHANGE MANAGEMENT SYSTEM AND METHOD, AND CONTRIBUTION AND SHARING SYSTEM AND METHOD ASSOCIATED THEREWITH

(71) Applicant: Changejar Inc., Ottawa (CA)

(72) Inventors: Tom Camps, Ottawa (CA); Pasan Weerasinghe, Burlington (CA); Neal Stansby, Ottawa (CA); Robert Nielsen, Ottawa (CA)

(21) Appl. No.: 15/141,539

(22) Filed: Apr. 28, 2016

Related U.S. Application Data
(60) Provisional application No. 62/295,603, filed on Feb. 16, 2016.
(60) Provisional application No. 62/158,428, filed on May 7, 2015.
(60) Provisional application No. 62/158,427, filed on May 7, 2015.

(30) Foreign Application Priority Data
Aug. 31, 2015 (CA) 2901949

(51) Int. Cl. G06Q 20/20; G07F 19/00; G06Q 20/32; G06Q 20/40; G06Q 20/36; G06Q 20/26

(52) U.S. Cl. CPC G06Q 20/204; G06Q 20/3672; G06Q 20/26; G06Q 20/3227; G06Q 20/3223; G06Q 20/401; G07F 19/202; G06Q 2220/00

(57) ABSTRACT

In some embodiments, a mobile cash change processing system for processing cash change to be returned to a user in return for cash payment transaction executed at a retailer location includes a server remotely operable to execute electronic monetary transactions between digitally stored accounts and having stored in association therewith: user account data associated with each of a plurality of registered user accounts; retailer account data associated with each of a plurality of registered retailer accounts; and sharing account data associated with each of a plurality of registered sharing accounts. The system further includes a digital mobile application operable on the user's mobile device to: invoke communication of a cash change return identifier to said server, receive identification of a sharing account associated with the retailer location; display a selectable sharing option to the user; and communicate user selection to said transaction server to invoke an electronic transfer of funds.

### CROSS-REFERENCE TO RELATED APPLICATIONS

This application claims priority to U.S. Provisional Patent Application No. 62/158,428 filed May 7, 2015, U.S. Provisional Patent Application No. 62/158,427 filed May 7, 2015, U.S. Provisional Patent Application No. 62/295,603 filed Feb. 16, 2016, and Canadian Application No. 2,901,949 filed Aug. 31, 2015. Each of these prior applications is incorporated herein by reference.

### FIELD OF THE DISCLOSURE

The present disclosure relates to mobile devices, systems and applications, and, in particular, to a mobile cash change management system and method, and contribution and sharing system and method associated therewith.

### BACKGROUND

Despite the recent advent of mobile payment applications, and the longstanding use of credit and debit cards, cash payments remain a relatively common form of payment, particularly when purchasing low value items or services, such as food and beverage items, transportation fares, etc. Accordingly, credit card companies have increasingly encouraged the use of quick pay credit card options for such low value purchases, namely via the use of near-field communication (NFC) terminals and the like that can be activated for purchases, for example, below $100, so to further benefit from the transaction fees that can be charged to merchants for such purchases. Similarly, while mobile payment transactions can have a positive impact on the facility with which payment transactions can be processed both from the perspective of the user and the merchant, such transactions can also have some drawbacks as they necessarily invoke the application of electronic transaction fees to the merchant and/or user for an increasing number of transactions.

Overall, the continuous development and promotion of easy-to-use mobile payment applications has the potential to shift more transactions to that of the credit cards associated with current mobile payment systems, and thus, to further burden merchants with transaction fees. In order to mitigate this evolution, merchants must seek new ways to provide greater automation and versatility to mobile device users so to encourage continued cash payment transactions for traditionally cash-exchanged purchases and thus reduce applicable transaction fees.

U.S. Patent Application Publication No. 2012/0116956 to Altman et al. provides one mobile solution for the management of cash transactions, namely in allowing cash change due in return for a cash payment to be electronically captured by the user's mobile device and stored against a stored value card account to be redeemed downstream against a subsequent purchase. The disclosed solution is seemingly restricted to the accumulation of cash change credits against a users stored value card(s) for subsequent redemption.

Mobile payment options executable in the context of Web and/or mobile payment applications are otherwise growing in popularity, facilitating execution of electronic payments to participating merchants from a user's mobile device. Examples of such mobile payment applications include those currently provided by Google™ (Google Wallet) and Apple™ (Apple Pay), and other mobile application developers in the mobile payment industry. Much like a credit card transaction, a user account identifier is transmitted from the user's mobile device via a near-field communication (NFC) interface or the like at a participating point-of-sale (POS) location, which is then relayed to an appropriate transaction processing authority along with transaction details to be processed against the user's account in completing a given financial transaction. The user benefits from a relatively seamless and effortless transaction process implemented directly via their mobile device, and thus avoiding the use of physical credit or debit cards, which can be lost, stolen or electronically defrauded.

While increasingly popular, the provision of mobile payment solutions also has its drawbacks, particularly as it compares to traditional cash payment options, for example in challenging the otherwise relatively straightforward option of leaving a tip for services rendered, or again, making other monetary contributions to services, charities or related causes sponsored by or otherwise related to the POS location. For example, traditional cash payment transactions would generally lead to the return of cash change that could be left as a tip, in whole or in part, to a particular service provider, in a common tipping jar, or again added to a charity fundraising box or the like located at the POS location. In those circumstances, the customer, at their discretion, can discretely leave behind a selected amount of money as a sign of appreciation for the services rendered, or again in support of the sponsored cause or charity. Processing such contributions via POS credit or debit card transactions becomes less discrete, generally requiring the sales person to request out loud whether the customer wishes to leave a tip or make a donation, or at best, allowing the customer to make such selection on-the-spot using a dedicated POS card reader interface. For example, this interface can be used to confirm the transaction, enter a personal identification number or PIN in some instances, and go through one or more tipping options to be processed concurrently with the transaction and immediately visible to the POS operator executing the transaction.

Using current mobile payment applications, or the cash change management options noted above, the option of leaving a tip or other related monetary contribution does not exist, or at best, would require the customer to confirm their interest out-loud to the merchant before the transaction is finally processed so to be included in the transaction total. A similar challenge exists in the processing of payments from stored value cards, gift cards, customer loyalty cards and the like.

Some examples have been provided in the art to automate processing of charitable donations against electronic transactions. For example, U.S. Pat. No. 7,080,775 to Gorelick describes a process in which a monetary contribution associated with a donor is automatically determined and processed by rounding an amount associated with a given billing instrument, and collecting the difference between the rounded amount and the billed amount of the instrument to be applied to a target charity account. Using this process, each transaction is indiscriminately processed without user input or discretion, and applied across all transactions to a target account irrespective of the source of the billing instrument.

This background information is provided to reveal information believed by the applicant to be of possible relevance. No admission is necessarily intended, nor should be construed, that any of the preceding information constitutes prior art.

### SUMMARY

The following presents a simplified summary of the general inventive concept(s) described herein to provide a basic understanding of some aspects of the invention. This summary is not an extensive overview of the invention. It is not intended to restrict key or critical elements of the invention or to delineate the scope of the invention beyond that which is explicitly or implicitly described by the following description and claims.

A need exists for a mobile cash change management system and method, and financial contribution and sharing system and method associated therewith, that overcome some of the drawbacks of known techniques, or at least, provide a useful alternative thereto. Some aspects of this disclosure provide examples of such systems and methods.

In accordance with one aspect, there is provided a mobile cash change processing system for processing cash change to be returned to a user in return for a cash payment transaction executed by this user at a given retailer location, the system comprising: a monetary transaction server remotely operable to execute electronic monetary transactions between digitally stored accounts, said server having stored in association therewith: user account data associated with each of a plurality of registered user accounts; retailer account data associated with each of a plurality of registered retailer accounts; and sharing account data associated with each of a plurality of registered sharing accounts, wherein each of said sharing accounts is directly or indirectly associated with a respective retailer account. The system further comprises a digital mobile application operable on the user's mobile device to: invoke communication of a cash change return identifier associated with the cash payment transaction to said server, wherein said return identifier digitally identifies a cash change amount, a given user account associated with the user and a given retailer account associated with the cash payment transaction at the given retailer location, and wherein receipt of said communication by said server results in an increase to an available sharing balance associated with said given user account corresponding to said cash change amount to be debited from said given retailer account; receive identification of a given sharing account associated with the given retailer location; display a selectable sharing option to the given user via a graphical user interface of said mobile device in which information pertaining to said given sharing account is visibly rendered for the given user, wherein selection of said sharing option authorizes a monetary sharing amount to be transferred to said given sharing account from said available sharing balance; and communicate user selection of said sharing option to said transaction server in response to said user selection so to invoke an electronic transfer of funds corresponding to said sharing amount from said available sharing balance to said sharing account.

In accordance with one embodiment, the mobile application is further operable to receive at least part of said cash change return identifier from a POS terminal associated with the cash payment transaction that digitally identifies said cash change amount and said retailer account, and directly communicate said cash change return identifier to said server for processing.

In accordance with one embodiment, the mobile application is further operable to make accessible to a POS terminal a user account identifier to be relayed by said POS terminal to said server along with identification of said cash change amount and said retailer account, for processing.

In accordance with one embodiment, the system further comprises a POS terminal interface to said server operable on each of a plurality said POS terminal.

In accordance with one embodiment, the mobile application is further operable to: display a selectable cash change processing option to the user comprising at least: a cash change deposit option in which at least a portion of said cash change amount is to be deposited in said given user account; and said selectable sharing option in which at least a portion of said cash change amount is to be deposited in said given sharing account; record user selection of at lest one of said processing options; and communicate a mobile transaction communication to said transaction server in response to said user selection so to invoke a direct or indirect electronic transfer of funds at least partially corresponding to said cash change return amount from said given retailer account corresponding to a selected one or more of said given user account and said given sharing account; wherein said transfer of funds is implemented by the server upon receipt of said transaction communication from the user's mobile device.

In accordance with one embodiment, the given sharing account comprises a tipping account or a social giving account associated with said given retailer account or a given POS location associated therewith, and wherein said cash change sharing option comprises a selectable sharing amount to be redirected from said cash change return amount to said sharing account upon processing said cash change return amount.

In accordance with one embodiment, the cash change amount is first transferred in full from said given retailer account to said given user account in increasing said available balance, and wherein said sharing amount is subsequently transferred from said given user account to said sharing account in response to selection of said sharing option.

In accordance with one embodiment, the given sharing account comprises a tipping account or a social giving account associated with said given retailer account or a given POS location associated therewith.

In accordance with one embodiment, the user selection of said sharing option is processed anonymously between said mobile application and said transaction server such that a POS location associated with said given retailer account is blind to an originator of said sharing amount.

In accordance with one embodiment, the transaction server has further associated therewith a transaction analytics engine that compiles demographics on at least one of tipping amounts, tipping rates and/or tipping frequencies; donation amounts, donation rates, donation types and/or donation frequencies; types of individuals most likely to perform cash transactions; and the like.

In accordance with one embodiment, the cash change return identifier further identifies a cash payment amount for said cash payment transaction, and wherein said sharing option includes a selectable sharing amount defined as a function of said cash payment amount.

In accordance with one embodiment, the available balance is further increased by an added monetary cash payment incentive amount automatically added to said cash change return amount and debited from said given retailer account.

In accordance with one embodiment, the cash change return identifier further identifies a cash payment amount for said cash payment transaction, and wherein said added monetary cash payment incentive is automatically calculated as a function of said cash payment amount.

In accordance with one embodiment, the part of said cash change return identifier is received from said POS terminal via a printed scan-code identifier, a manual input identifier or a short-range digital communication identifier output by said POS terminal.

In accordance with one embodiment, the user account identifier consists of a randomly generated client token previously associated with said given user account.

In accordance with one embodiment, the randomly generated client token consists of a single-use token.

In accordance with one embodiment, the server is operable to associate a set of two or more single-use client tokens with said given user account upon initialization thereof, and securely relay said set to said mobile application, each to be used thereby as said user account identifier in sequential transactions, wherein said server regularly updates said set with said mobile application as said single-use tokens are consumed.

In accordance with another aspect, there is provided a computer-readable medium having statements and instructions stored therein to be implemented by a digital processor of a mobile communication device to execute a mobile application on the mobile device in respect of a cash payment transaction executed at a point-of-sale (POS) location to: invoke communication of a cash change return identifier associated with the cash payment transaction to a transaction server, wherein said return identifier digitally identifies a cash change amount, a given user account associated with the user and a given retailer account associated with the cash payment transaction at the POS location, and wherein receipt of said communication by said server results in an increase to an available sharing balance associated with said given user account corresponding to said cash change amount to be debited from said given retailer account; receive identification of a given sharing account associated with the POS location; display a selectable sharing option via a graphical user interface of said mobile device in which information pertaining to said given sharing account is visibly rendered; record selection of said sharing option as authorization to execute transfer of a monetary sharing amount to said given sharing account from said available sharing balance; and communicate said selection of said sharing option to said server to invoke an electronic transfer of funds corresponding to said sharing amount from said available sharing balance to said sharing account.

In accordance with one embodiment, the computer-readable medium further comprises statements and instructions to receive at least part of said cash change return identifier from a POS terminal at the POS location that digitally identifies said cash change amount and said retailer account, and directly communicate said cash change return identifier to said server for processing.

In accordance with one embodiment, the computer-readable medium further comprises statements and instructions to make accessible to a POS terminal at the POS location a user account identifier to be relayed by said POS terminal to said server along with identification of said cash change amount and said retailer account, for processing.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a high level diagram of a mobile cash change management and sharing system architecture, in accordance with one embodiment;

FIG. 2 is an exemplary graphical user interface rendered on a mobile device to provide a sharing option to a user thereof in response to a cash payment transaction, in accordance with one embodiment; and

FIG. 3 is an exemplary graphical user interface rendered on a mobile device, in accordance with one embodiment, to provide a sharing option to a user thereof in response to a cash payment transaction, in accordance with another embodiment.

FIG. 4 is a high level diagram of a mobile cash change management and sharing system architecture, in accordance with another embodiment;

FIG. 5 is a process flow diagram of a mobile cash change management and sharing application activation and account initialization process implemented in a system as exemplarily shown in FIG. 4, in accordance with one embodiment;

FIG. 6 is a process flow diagram of a cash change capture process executed via the mobile application activated and account initialized in accordance with the process of FIG. 5, in accordance with one embodiment;

FIG. 7 is a process flow diagram of cash change payment process executed via the mobile application against a cash change balance accumulated via the cash change capture process of FIG. 6, in accordance with one embodiment;

FIG. 8 is a process flow diagram of a peer-to-peer cash change transfer process initiated via the mobile application against a cash change balance accumulated via the cash change capture process of FIG. 6, in accordance with one embodiment;

FIGS. 9 to 24 are exemplary screenshots of a mobile cash change management and sharing application, in accordance with one embodiment, in which:

FIG. 9 shows an activation page;

FIG. 10 shows an initial zero-balance transaction history page upon first activation;

FIG. 11 shows a change management page for executing a cash change capture or sharing function;

FIG. 12 shows a current balance and recent transaction history page;

FIG. 13 shows a searchable expanded transaction history page;

FIG. 14 shows a tip sharing function page;

FIG. 15 shows a charity sharing function page;

FIG. 16 shows a funds transfer amount entry page to initiate a peer-to-peer transfer;

FIG. 17 shows a user contacts page from which to select a pre-existing recipient for the peer-to-peer transfer initiated in the funds transfer amount entry page of FIG. 16;

FIG. 18 shows a confirmation window to confirm the peer-to-peer transfer selected from user contacts page of FIG. 17;

FIG. 19 shows a method-of-transfer selection page to execute the peer-to-peer funds transfer;

FIG. 20 shows an email transfer interface launched upon selection of the e-mail method-of-transfer on the selection page of FIG. 19, and identifying means for the intended recipient to complete the funds transfer;

FIG. 21 shows a short messaging interface launched upon selection of the messaging method-of-transfer on the selection page of FIG. 19, and including an embedded link allowing the intended recipient to complete the funds transfer;

FIG. 22 shows an onboard camera-mediated scancode interface launched upon selection of the scancode method of transfer on the selection page of FIG. 19, allowing for capture of a recipient scancode in executing and completing the funds transfer directly from the sender's mobile application;

FIG. 23 shows a notifications page listing push notifications received by the application and selectable in providing additional information, rewards and direct access to selected change management and sharing functions; and

FIG. 24 shows a slide-out utility menu accessible to toggle between account instances, settings, preferences and logs.

### DETAILED DESCRIPTION

The systems and methods described herein provide, in accordance with certain broad aspects of the present disclosure, different examples of a mobile cash change management system and method, and financial contribution and sharing system and method associated therewith. In accordance with other broad aspects, different examples of a token-based mobile monetary transaction system and method are also provided.

For greater clarity, the terms sharing and contribution will be used interchangeably herein to refer to a monetary amount transferred under control by the user to a designated account, for instance associated with a POS location in question and in response to a payment transaction previously executed at this location, and destined to benefit an entity or individual(s) associated with this designated account. It will be understood from the below description that the referenced sharing account destined to receive this sharing amount is distinct from a merchant account receiving a payment amount resulting from the payment transaction, but rather, reflects an entity or individual(s) associated with the merchant and registered to benefit from the user's sharing amount at the user's sole discretion. It will be nonetheless appreciated that while distinct accounts are considered herein, these distinct accounts need not necessarily constitute physically distinct accounts, but rather could also be defined by a same physical account destination provided transfer funds are appropriately designated and/or annotated in related transaction records to reflect their respective intended beneficiary.

In some embodiments, one or more available sharing options are relayed to a user's mobile device, for example in respect of a cash payment transaction being processed or previously processed at a given POS location, or in respect of a given retail establishment or merchant associated with this location. The mobile user may then discretely select a desired sharing option via their mobile device for processing, in some embodiments, unbeknownst to the POS operator, and optionally, as an anonymous donor/sharer from the perspective of the retail establishment/merchant associated with the POS location. In fact, in some embodiments, the mobile user may remain completely anonymous, that is even to the operator of the mobile system, much like regular cash transactions can be executed anonymously without prior or post-identification of the parties involved. Using the methods and systems described herein, the effective management of cash change provided in return for execution of a cash payment transaction is not only facilitated both for the merchant and the purchaser through electronic transaction means, but the purchaser is also provided with a discrete and streamlined option to share or give back some or all of the cash change returned to them in a given transaction, or again accumulated over time, for the benefit of an individual, group or entity associated with the POS location where the cash transaction(s) took place, all within the comfort and privacy of a mobile application operated on or in association with the purchaser's mobile device.

Furthermore, as will be described in greater detail below with reference to certain embodiments, but as will readily apply to various embodiments within and beyond the realm of the mobile cash change management systems considered herein, a token-based mobile monetary transaction system and architecture is also described to provide for robust and secure mobile transactions without significant burden to the end users. For instance, the token-based system described herein allows for users to execute transactions offline, for example, thus allowing greater access to mobile transactions irrespective of current mobile data or wi-fi coverage at any given point, and that, without compromising security settings surrounding the privacy of each user account, and the funds that may be available therefrom. For example, in one embodiment, a set of multiple client-specific single-use tokens are issued, stored and maintained for each client, whereby an active token is required to execute any of multiple transactions between user accounts. Provided one of the parties involved (i.e. a first party) is online to initiate the transaction, the first party can receive and relay the other party's client-specific single-use token even when this second party is offline, and execute the transaction and related funds transfer(s). The second party can continue to execute two or more offline transactions so long as further single-use tokens remain available on their device as part of the stored set of tokens. Upon regaining network coverage, the set of client-specific single-use tokens is refreshed on the mobile device for future use. Meanwhile, given the exchange of single-use tokens to identify and manage transactions between user accounts, the user's are exposed to limited risks of having their accounts significantly compromised, and the system is thus correspondingly exposed to limited liabilities on that front.

The systems and methods described herein also provide, in accordance with different embodiments, for the implementation of a mobile financial contribution and/or sharing transaction to be be executed in response to a mobile payment transaction in general, for example executed at a point-of-sale (POS) location or the like. For example, in some embodiments, one or more available sharing options may be relayed to a user's mobile device, for example in respect of a payment transaction being processed or previously processed at a given POS location, or in respect of a given retail establishment or merchant associated with this location. The mobile user may then discretely select a desired sharing option via their mobile device for processing, in some embodiments, unbeknownst to the POS operator, and optionally, as an anonymous donor/sharer from the perspective of the retail establishment/merchant associated with the POS location.

These and other applications, features, advantages and benefits will be described in greater detail below, in a non-restrictive manner, with reference to the below description of exemplary embodiments.

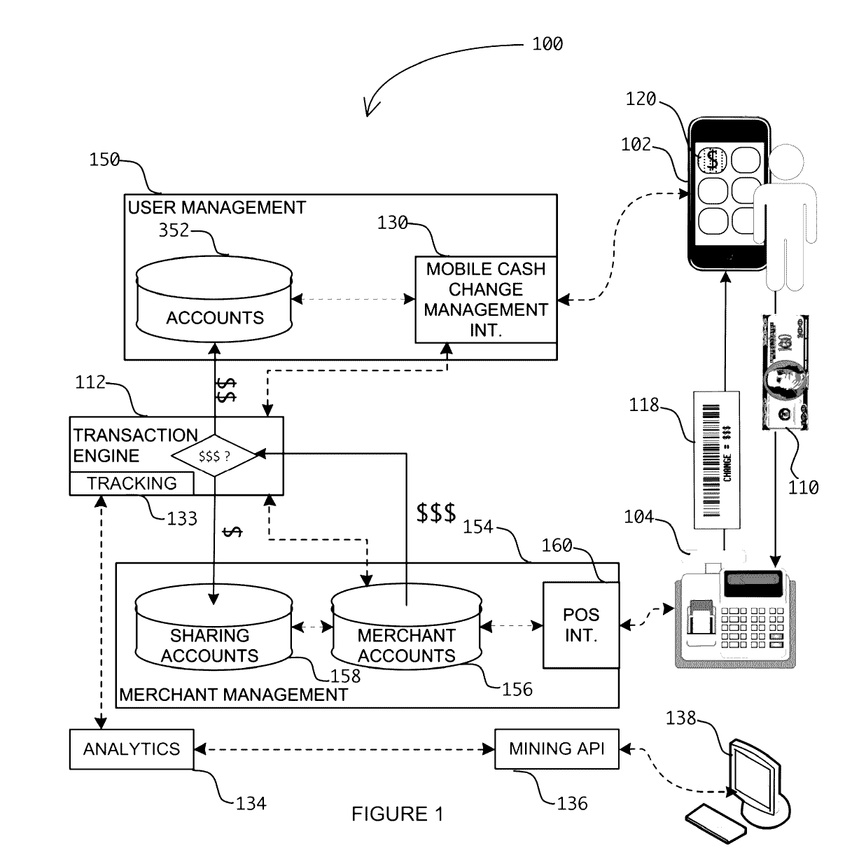

With reference now to FIG. 1, and in accordance with one embodiment, an example of a cash change management system 100 will now be described, in which financial sharing is provided via a user's mobile device 102 against single or accumulated cash payment transactions. For instance, a cash payment amount 110 is provided at a given POS location to be processed by a POS terminal 104 or the like. In return, the user is provided with a transaction identifier 118, in this embodiment consisting of a device-readable code such as a barcode, QR code, or the like, which can be scanned or otherwise input to the user's mobile device 102, for instance via a dedicated mobile transaction application 120 or the like. For example, a printed transaction receipt may include a barcode or QR code that can be scanned by the mobile device, for example via an integrated camera or the like, and automatically processed by the mobile application 320 to trigger available change management and sharing options. Similarly, such scan codes may be graphically rendered on a screen or interface associated with the POS to invoke similar functions. In yet other examples, a printed or graphically rendered code may be manually entered by the user via a user interface to the application 120. Alternatively, the transaction identifier 118 may consist of a manually enterable code or again, a wirelessly communicated identifier automatically communicated to the user's mobile device 102 and/or application 120 via an appropriate short-range communication protocol such as NFC or the like.

In any event, upon processing of the transaction identifier 118, a related cash change management and sharing transaction may be initiated via the user's mobile device 102 and executed, whereby at least part of the cash change to be physically returned in response to the cash payment transaction 110 is not only instead processed electronically by the system 100, but further used to encourage financial sharing by the user with an account associated with the POS location. For example, sharing options may include the option to authorize a sharing transaction for a given sharing fraction or all of the total cash change due amount between the user's account 152 and a sharing account 158 directly or indirectly associated with the POS location, for instance where the full cash change due amount is first transferred from the merchant account 156 to the users' account 152. In the illustrated example, a sharing option may rather include the option to authorize a sharing transaction for a given sharing fraction or all of the total cash change due amount to be redirected from the merchant account 156 to the sharing account, with the remainder directed to the user's account 152. Examples of available sharing accounts may include, but are not limited to, one or more of a general or dedicated tipping account associated with the POS location, merchant or retail establishment; a designated charity account corresponding to a given charity sponsored, supported or otherwise preselected by an establishment associated with the POS location; a fundraising account corresponding to a given fundraising effort or cause sponsored, supported or otherwise preselected by an establishment associated with the POS location; and other conceivable social giving/sharing accounts that may be sponsored and/or supported by the POS location.

In this particular example, the transaction identifier 118 includes a cash change return identifier associated with the cash payment transaction 110, and can be used by the system 100 to digitally identify a cash change amount due to the user (illustratively identified as “$$$” in FIG. 1) and a POS location, or an establishment associated therewith. The transaction identifier 118 is received by the mobile device 102 and illustratively processed via an executable cash change management application 120 operating thereon to display one or more selectable cash change processing options to the user via a graphical user interface (GUI) of the mobile device 102. In one embodiment, these options comprise at least one cash change deposit option in which at least a portion of the cash change amount due is to be deposited in a given user account associated with the user, and at least one cash change sharing option in which at least a portion of the cash change amount due is to be deposited in a given sharing account visible to the user via the GUI as being associated with the POS location. The user's processing selection is recorded by the application 120 and ultimately communicated by the mobile device 102 via a user mobile cash change management interface 130 for processing by a centralized transaction engine or server 112.

In this embodiment, a user management module 150 maintains user account data in a user accounts database 152 for each of the system's users and which is at least in part accessible to the end user via the user interface 130 and accessible to the transaction engine/server 112 to process change-related transactions. Likewise, a merchant management module 154 maintains merchant account data and sharing account data in a merchant account database 156 and a sharing account database 158, respectively, which are also at least in part accessible to the transaction engine/server 112 to process change-related transactions. The merchant account data and/or sharing account data may also be accessible via a POS interface 160 to the POS terminal 104, or another POS-related terminal. As will be appreciated by the skilled artisan, while user management module 150 and merchant management module 154 are shown as distinct modules each managing inputs/outputs of respective user, sharing and merchant account databases, all data management functions may be fully or partially executed within the context of a same or distinct management modules and/or databases, and that, without departing from the general scope and nature of the present disclosure. Further, while generic account data references are discussed in the context of the present embodiment, it will be appreciated that such user, merchant and sharing accounts may interchangeably relate to traditional electronic financial accounts, such as that managed by accredited financial institutions, relate to data management accounts operatively and/or virtually linked to such financial accounts and used periodically to execute appropriate account transfers and transferred fund allocations, or other such accounts as may be readily appreciated by the skilled artisan. Furthermore, while distinct modules, databases and engines are illustrated in this example to better illustrate and convey the various functionalities of the system at hand, it will be appreciated that these various components may equally form part of an integrated transaction server or the like having one or more hardware processors, a remote network interface, and direct or communicative access to unitary or distributed data storage resources such as a network accessible database and the like.

Upon receipt of the user's sharing selection via the user interface 130, the transaction engine/server 112 will process the selection accordingly between the respective accounts involved. In the illustrated example, the user selected to transfer a personal portion ($$) of the change amount due ($$$) to their personal account balance stored in the user account database 152, and the remaining amount as a sharing portion ($) to the sharing account 158 associated with the POS location. Accordingly, funds corresponding to the total change due amount ($$$) are electronically transferred from the merchant account 156 associated with the POS location and split by the transaction server/engine 112 between the user's account 152 and the selected sharing account 158 in accordance with the user's sharing selection. As noted above, the full amount due may otherwise be transferred from the merchant account to the user account, followed by a subsequent sharing transfer of the selection portion from the user account to the sharing account. Similarly, while the user may select to share a portion of the cash change amount due in respect of a given transaction, the user may otherwise select to transfer a larger amount that exceeds the amount due or recently transferred, for example drawn from accumulated funds previously transferred in respect of one or more cash transactions and represented by an total available balance associated with the user's account.

As an illustrative example, the user may execute a cash payment for a $15 purchase by handing a $20 bill to the operator of the POS terminal104. In return, the POS terminal 104 outputs a transaction identifier 118 usable to electronically identify the $5 in cash due to the user, as well as link this change amount to the POS location, or an establishment associated therewith. Note that in this exchange, the user's identity remains completely anonymous to the POS operator and location. As noted above, the user may in fact remain anonymous to the system as a whole where an anonymous account has been setup and initialized to interface anonymously with the user's mobile device.

Upon receiving input of the transaction identifier 118 (e.g. via manual input, image or scan code input, automated NFC input, etc.), the change management application 120 on the user's mobile device 102 will relay the POS identifier to the user management module 150 via mobile interface 130 to directly or indirectly access identification of sharing options associated with the POS location from the merchant account or related database of the merchant management module 154. These POS-related sharing options are then relayed back to the user's mobile application 120, including one or more of a POS-related sharing account(s), a suggested sharing amount(s), further information on the identified beneficiary of the shared amount or how the POS-location is related thereto, co-sponsorship or top-up contributions to be provided by the POS-location or an establishment associated therewith in response to each or global sharing amounts, and the like. In embodiments where multiple sharing options are provided, the user may select one or more of these options for sharing. The user may also be provided with the option to select a sharing amount to be shared, approve a preselected amount, and/or enter/edit an amount of their choosing. Ultimately, the user may select to either process the change amount to their own account in full, or divert the change amount, in whole or in part, to the sharing account(s). The user selection is then sent back via the mobile interface 130 to be processed by the transaction engine 112 in executing appropriate electronic funds transfers accordingly.

In the illustrated example of FIG. 1, the cash change transaction(s) is(are) executed only once upon receipt of the user's sharing selection. Namely, upon the user receiving notice of the available sharing options, the user then makes a selection which is communicated to the system server(s) and ultimately results in the direct or shared cash change transaction(s) to take place (i.e. from the merchant account to either one or more of the user account and the sharing account).

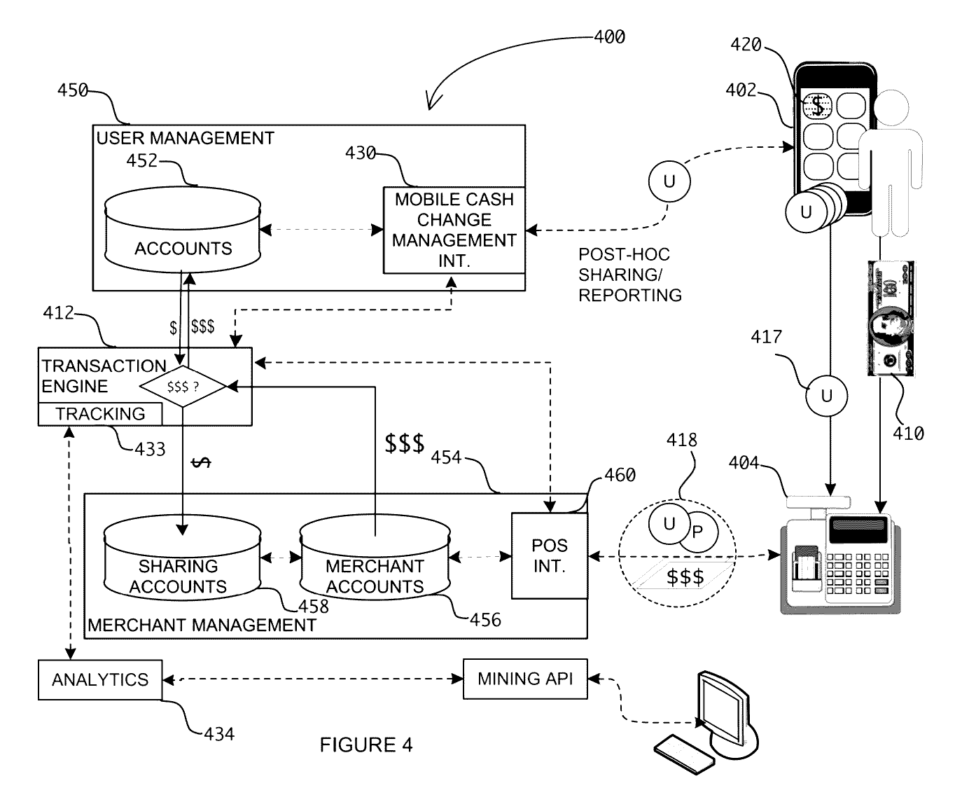

In other embodiments, however, a first cash change management transaction may be invoked between the merchant account and the user account, to be followed by a related sharing transaction from the user account to a designated sharing account, as shown illustratively in FIG. 4. For example, the whole amount of the cash change due may be directed to the user account from the retailer account immediately by the transaction engine 112 upon the mobile cash change management interface 130 receiving input of the change identifier 118. The user may then concurrently receive confirmatory notice of the successful cash change transaction (e.g. identified by an increase in the user's available account balance being displayed via the mobile application 120) along with one or more sharing options associated with this transaction. By default, the user would then receive the full amount of the cash change due (much as in a standard cash transaction), and then have the option to execute a sharing transaction, in response to which, a subsequent sharing transaction would be executed by the transaction engine 112 to transfer a shared amount from the user's account to the designated sharing account. As will be appreciated by the skilled artisan, this sharing transaction may be executed more or less immediately upon receipt of a sharing option notification or message, or later, for example, upon the user revisiting this sharing option notification or message or upon receipt of a reminder notification after a preset delay. These and other such options will be described in greater detail below.

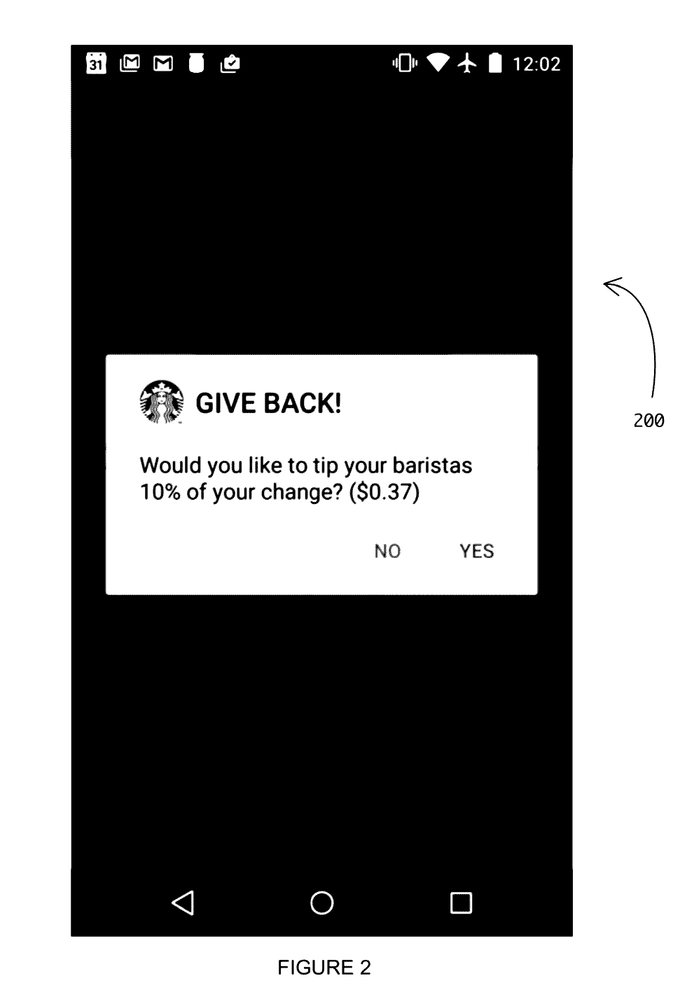

With added reference to FIG. 2, and in accordance with one embodiment, an exemplary screenshot is provided of a graphical user interface 200 rendered to the user of a mobile device 102 registered with the mobile cash change management system 100 of FIG. 1 upon input of a given transaction identifier 118. In this example, the user inputs a transaction identifier related to the cash purchase for a coffee at a given coffee shop, such as Starbucks™. In this example, the cash transaction resulted in a change amount due of $3.70 (e.g. to be returned in exchange for a $10 bill rendered in executing payment for a $6.30 transaction). The cash change management application 120 running on the user's mobile device 102 accesses relevant sharing options related to the POS location in question, and returns a message for display to the user via the GUI 200 providing the option for the user to select to share 10% of the change owed ($0.37) to a barista tipping account associated with this POS location (e.g. a location-specific account, a barista-specific account associated with the particular barista registered as having executed the transaction, or a local, regional or global barista tipping fund, etc.). Alternatively, a tipping option may rather include the option to share a percentage of the transaction amount paid as opposed to the change owed, provided of course that the available balance in the user's account can cover that amount. Upon selecting “yes”, the suggested sharing amount is transferred from the merchant account to the sharing account in question, and the remainder of the change amount due is transferred from the merchant account to the user account. Upon selecting “no”, the full change due amount is transferred to the user account from the merchant account. As will be appreciated by the skilled artisan, the full change due amount may alternatively be transferred from the merchant account to the user account in full irrespective of user selection, first, and then a sharing amount transferred from the user account to the designated sharing account upon processing of the user selection.

As shown in the background of the GUI 200, the user also has access to a recent cash change transaction history, in this case showing a recent input of $3.70 to the user account in response to an immediately processed cash purchase transaction, as well as previous sharing transactions of $0.91 and $0.17 associated with a same or previously frequented merchant locations. Other functions shown in this example include a “GIVE” function, in which various giving features may be invoked such as post-hoc sharing and reporting functions, as well as a “GET” function, in which one or more cash change capture functions may be invoked.

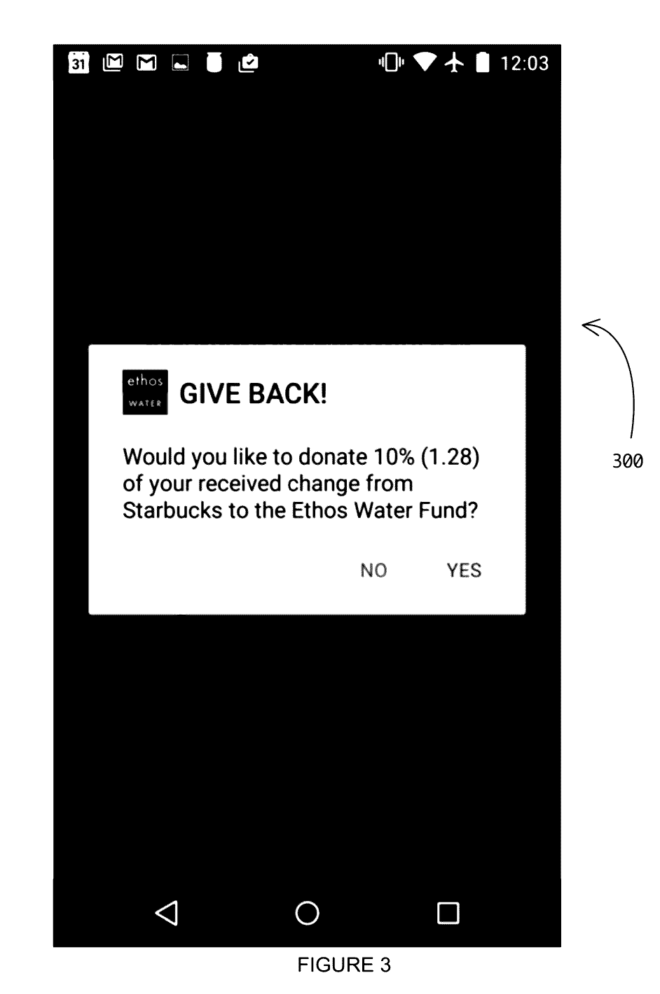

With reference to FIG. 3, a similar example is provided of a graphical user interface 300, in this example providing the user the option to donate part of the cash change due to Starbacks' Ethos Water Fund, a charitable organization associated with the merchant, Starbucks, where the recent cash payment transaction was completed. Background options also shown allows the user to review details associated with sharing accounts previously shared to, or again, associated with retail establishments previously frequented and to which a user may ultimately chose to contribute to in response to a future transaction, or again against previous transactions in a post-hoc manner.

With reference again to FIG. 1, the system architecture illustrated therein further allows for expanded data analytics and post-hoc user sharing transactions unavailable using traditional payment methods. For instance, in the illustrated embodiment, the transaction server 112 may further include a tracking module or function 133 and sharing data analytics engine 134 operatively associated therewith to compile and analyse cash transaction and user-sharing data to provide further cash change management and sharing-related functions and features.

For example, in one embodiment, the analytics engine 134 may be configured to securely compile user-specific transaction/sharing data to push post-hoc sharing options to the user via the mobile interface 130 and mobile application 120 operating on this user's device 102. For example, a monthly digest could be compiled for the user to report on the user's transaction activity in respect of one or more targeted or participating merchants and allow the user to make a retrospective analysis of their spending and/or sharing activity in relation to a particular merchant and select to execute a post-hoc sharing contribution to a sharing account associated with this particular merchant. For example, a regular patron to a particular coffee shop or chain may elect to forgo making ad hoc sharing contributions related to this coffee shop in favour of making a monthly sharing contribution, for example based on a total spending for that particular month, a general perception as to their overall experience that month as a patron to this establishment, or again based on an available balance of funds in their account.

Furthermore, where the sharing account in question is associated with a charitable organization registered to issue tax receipts against donations made over a minimum amount, the user may elect to make a single monthly donation over ad hoc donations to so meet this minimum amount for the month and thereby benefit from the issuance of an appropriate tax receipt. Following from this example, the transaction server's tracking module 133 would be further configured to aptly track each user's specific contributions and relay appropriate information to an entity associated with the sharing account in question to enable the issuance of the user's tax receipt, which may be issued electronically in one example, and delivered via the mobile sharing application 120.

In some embodiments, the analytics engine 134 may further or alternatively anonymously compile global sharing details to output general sharing statistics or trends, for example against user demographics, merchant characteristics, and the like, for access by registered users via a data mining API 136, for instance providing data access to a remotely located mining terminal 138 or the like over a secure network (e.g. Internet) connection. Once again, since sharing transactions are generally initiated by the end user via their own mobile device 102 via a dedicated, or at least POS-agnostic sharing server 112, user anonymity can be further protected and maintained in rendering analytics data through the mining API 136. As will be described in greater detail below, however, other embodiments may rely on POS-initiated cash-back transactions while still allowing for user anonymity.

In yet another embodiment, the analytics engine 134 may be configured to relay relevant sharing statistics and/or averages to the user via the mobile interface 130 to the user's mobile application 120, for instance to incentivize or encourage further sharing. For example, a user's average or overall sharing level (e.g. over a given time period) could be computed and relayed to the user via the mobile application 120 when delivering a particular selectable sharing option in respect of a recent payment transaction. Exemplary messages could include, but are not limited to: a) providing a total shared amount for the user within a recent time period; b) providing a total shared amount within a recent time period or a historical average thereof for the user at a given establishment; and c) providing a comparative sharing level contribution for the user against their peers, other patrons at a particular POS location or establishment, or within their demographics. In the last example, the relayed sharing status indicator may, for instance, identify the user as an above or below average sharer, thus encouraging increasingly higher sharing amounts from patrons routinely identified as poor sharers.

Again, given the discretion afforded by the user-centric mobile application implementation, the user is saved from public embarrassment or pressure, while still invoking some personal pressure or encouragement toward higher sharing contributions. Similarly, the merchant may benefit from higher contributions being associated with their selected sharing accounts, without exposing their patrons to public discomfort and exposure.

Furthermore, while mobile and credit card payment transactions generally allow for electronic tracking and downstream data processing and/or mining, cash transactions are by default predominantly anonymous in nature. Namely, by executing a cash payment in a given transaction, the merchant is generally blind to the identity and demographic and purchasing habits of the purchaser. Such data analytics is of significant value to merchants in aligning products and marketing to their target and return audiences, and tracking of cash transactions thus presents a significant gap in otherwise available data tracking.

Using the system of FIG. 1, such data analytics may be further extended to cash transactions, not only in tracking how returned change is ultimately processed and/or shared, but also in identifying those cash patrons most likely to share, most likely to process cash payments in the first place, and their general purchasing habits and demographics.

Furthermore, as cash payment transactions may ultimately be preferred by merchants over credit card or mobile payment transactions given associated transaction fees (e.g. 1-4% of the purchase amount), merchants may favour these patrons by encouraging them to make further cash payments, or again encourage others to make cash payments, for example by providing generous top-up sharing amounts to selected user sharing amounts, or again providing cash-back incentives (e.g. 0.5%) to cash payment users, which in the end, are far more financially advantageous to the merchant over the significantly higher transaction fees charged by standard credit card companies.

Unlike traditional methods, where a user is either asked to execute a sharing selection and contribution (e.g. tip, charity donation, sponsorship, etc.) directly via the POS terminal 104 or operator thereof (e.g. cash tip or donation contribution), the user in these embodiments can discretely execute the selected sharing transaction via their mobile device 102 such that a desired contribution is still made, but without external pressure, real or perceived, from the POS operator. Furthermore, the illustrated embodiment brings forth the ability to execute a user-initiated sharing contribution where such contributions were heretofore impossible to execute using traditional mobile payment methods.

Ultimately, the illustrated architecture empowers the user to discretely execute ad hoc sharing contributions, that is on a per-transaction basis, and for the benefit of a sharing destination that is directly or indirectly associated with the POS location. For instance, in contrast with previously suggested methods that either impose a POS-initiated sharing transaction interface (e.g. within the context of a tip function integrated within a POS credit card payment terminal or the like or again within the context of traditional cash payment transactions where a financial contribution is readily visible if not directly handled by the POS operator), or rather universally imparts an automated monetary contribution to a universally-defined target account without user interaction, the user may selectively execute a sharing transaction in respect of a given transaction or for a given establishment or POS location and for a given sharing account distinctly associated with this particular POS location, and that, without the need to directly interface with the POS terminal or operator, but rather with the privacy and downstream anonymity afforded by their own personal mobile device.

With reference to FIG. 4, and in accordance with another embodiment, an alternative cash change management system 400 will now be described. In this example, a mobile application 420 executed on a user's mobile device 402 is again used to invoke execution of electronic cash change management and sharing functions, in this case, however, on the basis of a transaction identifier 418 relayed by a POS terminal 404 rather than by the mobile device 402. Sharing options, as will be described below, are nonetheless still executed from the comfort of the user's mobile device, but in this case, only upon an available cash change balance is accumulated via one or more cash change transactions initiated by participating POS terminals 404 or the like.

In this particular example, a cash payment amount 410 is provided at a given POS location to be processed by a POS terminal 404 or the like. In return, the user is provided with the option of receiving cash change directly, or electronically via execution of an electronic cash change transaction. Upon opting to proceed with the electronic transaction, the user will activate the mobile application 420 to relay a user account identifier, in this embodiment taking the form of a client-specific single-use token 417 identifiable by the system 400 to correspond with the user's account 452, to the POS terminal 404. In some examples, the token may take the form of a machine scannable code (e.g. 16 digit barcode) or the like, or again of an electronic token relayed automatically via a POS NFC terminal.

In any event, a cash change return identifier 418 is ultimately packaged by the POS terminal 404 to include the client identifier or token, a POS identifier or token (P) identifiable to correspond with a merchant account 456, a cash change amount due, and optionally metadata associated with the transaction such as location, time-of-day, total purchase value, purchased wares and details, etc.

Upon communication of the transaction identifier 418 via the system's POS interface 460, related cash change management and sharing functions may be initiated by the transaction server 412. The cash return amount ($$$) is first transferred from the merchant account 456 to the user account 452, along with an associated processing fee debited from the merchant account 456. A notification (e.g. push notification) is then relayed to the mobile application 420 via the mobile interface 430 identifying an available balance in the user's account as a result of the most recent transaction, as well as various transaction details or the like. In this example, this notification also serves to present or provide access to one or more sharing options associated with the executed cash transaction. As will be described in greater detail below, a fresh single-use client token is also securely relayed to the mobile application for future use.

Upon considering the one more sharing options available via the mobile application 420, the user may immediately execute a selected sharing transaction, or again execute it later in a post-hoc manner. In the illustrated example, the user selects to share a portion of the cash change provided ($), which selection is related via the mobile interface 430 to the transaction server 412 to execute a corresponding transfer from the user's account 452 to the designated sharing account 458.

Once again, a user management module 450 illustratively maintains user account data in a user accounts database 552 for each of the system's users and which is at least in part accessible to the end user via the user interface 430 and accessible to the transaction engine/server 412 to process change-related transactions. Likewise, a merchant management module 454 illustratively maintains merchant account data and sharing account data in a merchant account database 456 and a sharing account database 458, respectively, which are also at least in part accessible to the transaction engine/server 412 to process change-related transactions. The merchant account data and/or sharing account data may also be accessible via a POS interface 460 to the POS terminal 404, or another POS-related terminal.

As in the previous example, the system 400 also allows for expanded data analytics and post-hoc user sharing transactions unavailable using traditional payment methods. For instance, in the illustrated embodiment, the transaction server 412 may further include a tracking module or function 433 and sharing data analytics engine 434 operatively associated therewith to compile and analyse cash transaction and user-sharing data to provide further cash change management and sharing-related functions and features, as detailed above.

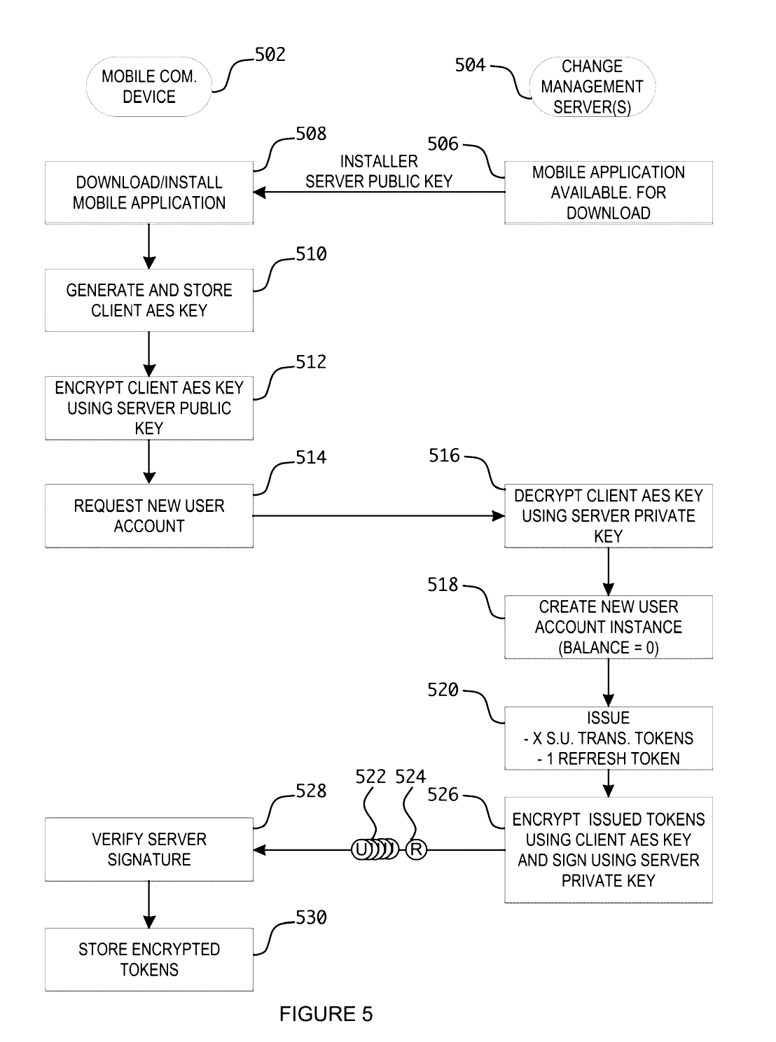

With reference now to FIGS. 5 to 8, exemplary system process flows will now be described in greater detail, in accordance with one embodiment.

For instance, FIG. 5 illustrates an exemplary mobile cash change management and sharing application activation and account initialization process, as implemented with the context of a system as illustrated in FIG. 4. In this example, the mobile application activation process is executed between a user's mobile (client) device 502 and a cash change management application server 504 or the like. The mobile application is generally made available for download and installation (506) from the server 504, or an app store or the like. The mobile device 502 will thus access and download or otherwise install the mobile application (508), which in this embodiment, comes with a server public encryption key hardcoded therein for downstream use in implementing various security and privacy measures. Once installed, the mobile application will automatically generate its own AES key (510), which is stored locally in the application file space and concurrently encrypted using the public server key (512) and relayed to the server in a request to initiate a new client account (514). In other embodiments, a mobile keychain functionality may be invoked, when available, to store the client's encryption key(s).

The server 504 processes the new account request by decrypting the client AES key using the server private key (516), and by creating a new user account instance having a default zero-balance (518). In some embodiments, multiple account instances may be created by a same user using respective devices, where each instance can be linked to a same general user account. For instance, installing the application on a device and creating an account (or attaching it to an existing account) will result in a unique instance being created and recorded. Tracking instances, in some embodiments, allows the system to alert the user when an account is accessed from a device (or web browser) that has not previously accessed it, to help detect compromised accounts. In the case of an account accessible from multiple instances, each hardware instance may be granted a distinct set of tokens, discussed further below. This means that when tokens are sent to the server to perform a transaction, the originating instance is known. For the sake of the following example, a single account instance will be considered, though similar functions and features may readily extend to accounts linking multiple account instances.

In the illustrated example, the creation of a new account instance triggers the issuance (520) of a set 522 of multiple client-specific single-use transaction (or user) tokens (U), and one refresh token 524 (R). In one example, five (5) or ten (10) user tokens are issued for each new account, though other quantities may readily apply. The issued tokens are encrypted using the client key and digitally signed using the private server key (526), and relayed to the mobile application 502 over an appropriate network connection. The application verifies the server signature (528) using its hardcoded public server key, and stores the encrypted tokens (530) for downstream use. The user's account and mobile application are now fully operational. It will be noted that while further account details could be provided to the server 504 in compiling user demographics and the like, the system as described herein may equally be implemented anonymously, that is, without any personal user information being exchanged between the mobile device 502 and the server 504. Namely, as will be described below, the token-based processes contemplated in this example provide sufficient information to securely and accurately link a user's mobile device with a cash change management account without ever needing to confirm the user's identity, or exchange account information for that matter. These and other features will become more apparent from the following examples.

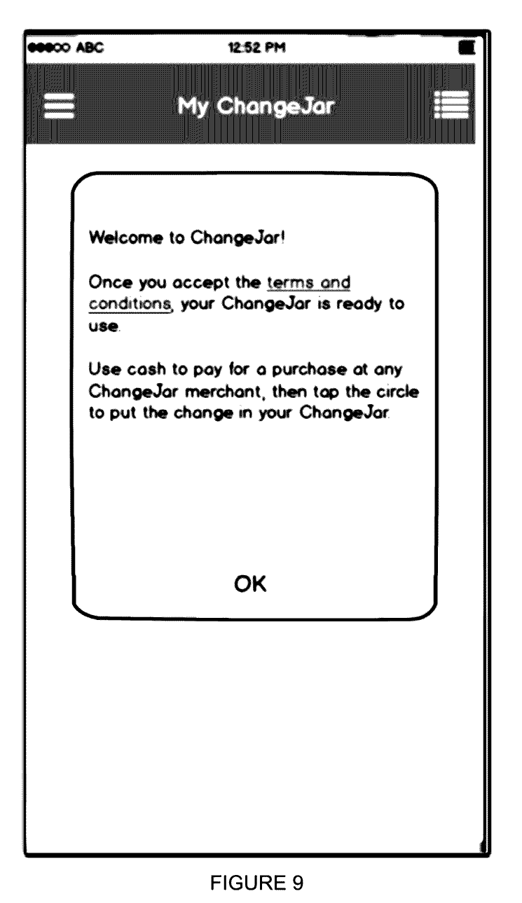

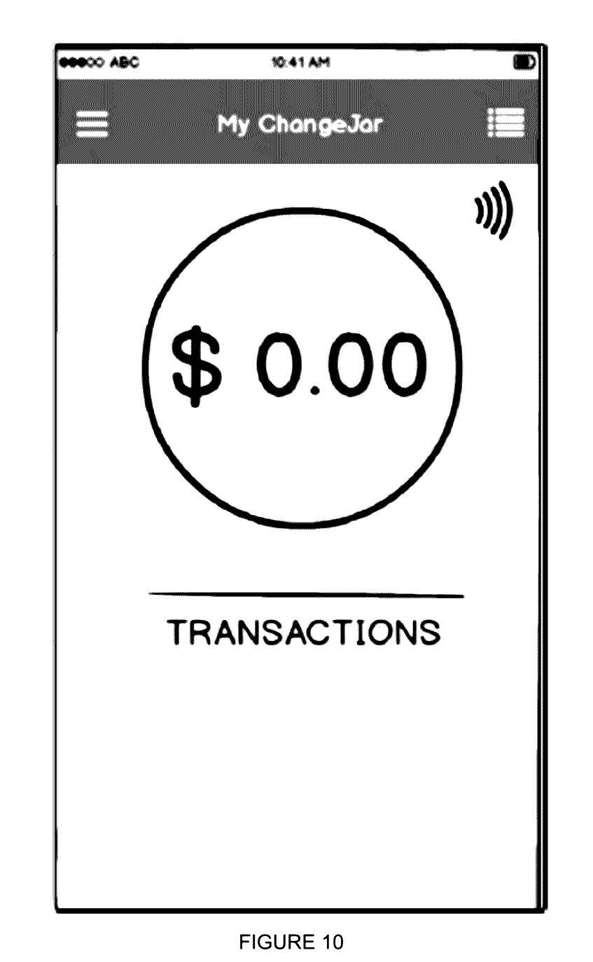

It should also be noted that the above activation and initialization process may be more or less executed with little to no user interaction. For example, the user may only need to select to purchase or freely download the mobile application onto their device, and have the rest of the process take place in the background without further input. The user's next interaction may simply be to activate the mobile application once initialized, accept certain terms and conditions (e.g. see screen shot of application activation page at FIG. 9), and be immediately directed to an initial zero-balance transaction history page, as shown for example at FIG. 10.

Similarly, each participating POS location will also require some form of initialization, which may vary depending on the type of terminal being operated at each location, and how these may be adapted to implement the functions and features considered herein. In this example, an initial single-use POS-identifying token can be relayed to the POS terminal over a secure connection via an existing PKI for SSL/TLS security, via physical delivery, or again via a similar process as described above for the issuance of secure client tokens to the mobile application.

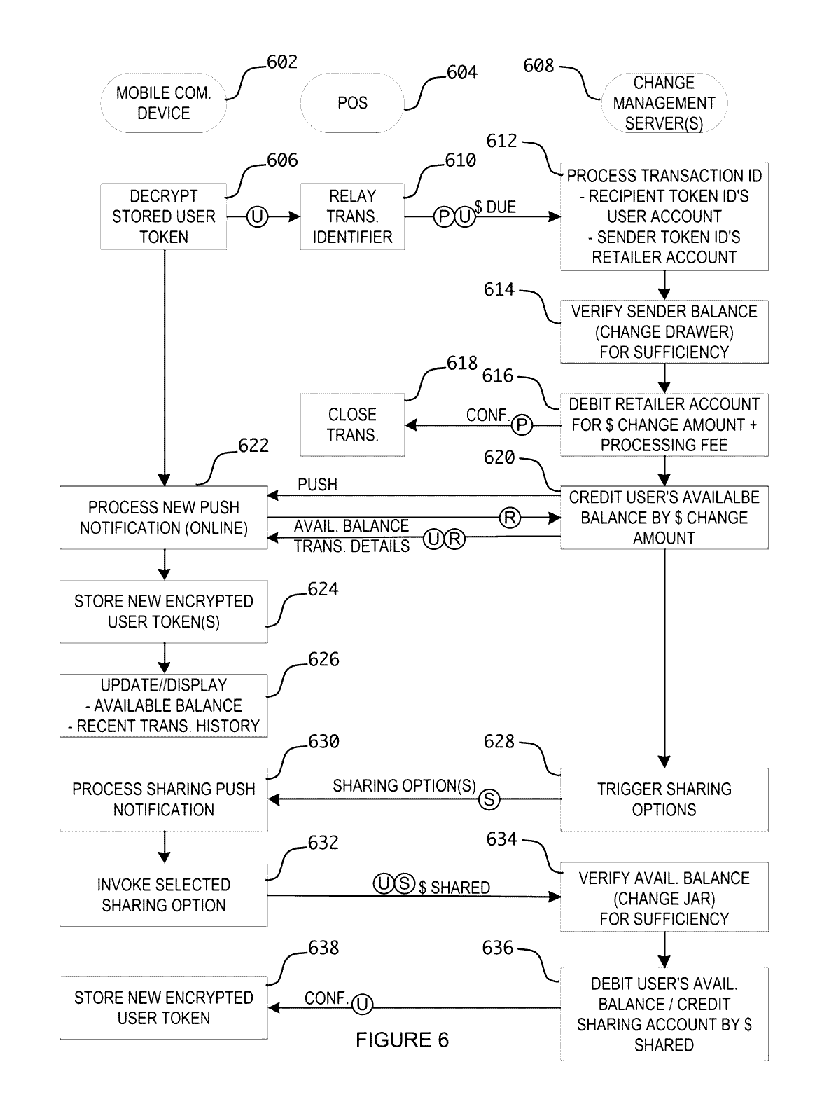

With reference to FIG. 6, a cash change capture process will now be described within the context of the mobile application and account activation and initialization described above with reference to FIG. 5. As introduced above with reference to FIG. 4, a cash transaction is first executed between a user of a mobile device 602 and a POS terminal 604. If the user elects to process a cash change return electronically, the user will activate their mobile application to decrypt one of their stored user tokens (606) via the client AES key, and invoke communication of a cash change return identifier associated with the recent cash payment transaction and including this user token to the server 608. In this example, the decrypted user token (recipient token) is first relayed to the POS terminal 604 (e.g. via NFC or a POS scannable code at 610), which then relays the decrypted user token, along with a POS-identifying (sender) token (P) and a cash change amount due to the user, to the server 608. Other transaction details may include a total amount of the cash transaction, what was purchased, and other metadata of potential interest to the merchant, user or related parties in downstream analytics. It will be noted that the mobile device 602 may be operated offline and still invoke the electronic cash change management function.

Upon receipt of the transaction identifier at the transaction server, the user account is identified from the recipient token, and the retailer account is identified from the sender token (612). The server verifies a sender balance (virtual change drawer of the POS location or establishment) for sufficiency of funds (614) before debiting the retailer account for the change amount due plus an applicable processing fee (616). A confirmation is generally sent to the POS 604 along with a fresh POS-identifying token, and the transaction is closed (618). Concurrently, the user's available balance will be credited in the amount due to it by the retailer (620). The server 608 will also issue a push notification to the client to be processed at 622. If the mobile device is currently offline, the push notification will be received upon regaining network access. In this example, the push notification triggers the transfer of details pertaining to the recent cash transaction (e.g. transaction amount and change credited to the user account), an available balance update (626), and the issuance of one or more fresh user tokens to replace the one(s) used in recent transactions, for example the one or more user tokens used while the application was operated offline.

To execute the latter, a client refresh request is directly executed between the client and the server in response to the push notification. For instance, any time the application acts in a transaction but is not the initiator of the transaction (i.e. does not act directly with the server), one of its transaction tokens must be replenished in a subsequent exchange with the server. If the application was in a disconnected state for some time, it may need more than one fresh token. At the same time, the server sends the current account balance and a list of recent transactions.

In the illustrated example, the application contacts the server in response to the push notification and requests a refresh, passing its refresh token as part of the request. The server then uses the refresh token to determine the account and instance to which the request applies. If there are pending refresh tokens for the instance, the server revokes them. The server counts the valid transaction tokens available for the account on the originating instance, and generates additional tokens as necessary to match the configured number of tokens for the instance. The server generates a new refresh token, in the pending state. All of the valid tokens and the new refresh token are sent to the application, encrypted with the application's key and signed with the server's private key, which are processed and stored (624) as noted above during account initialization.

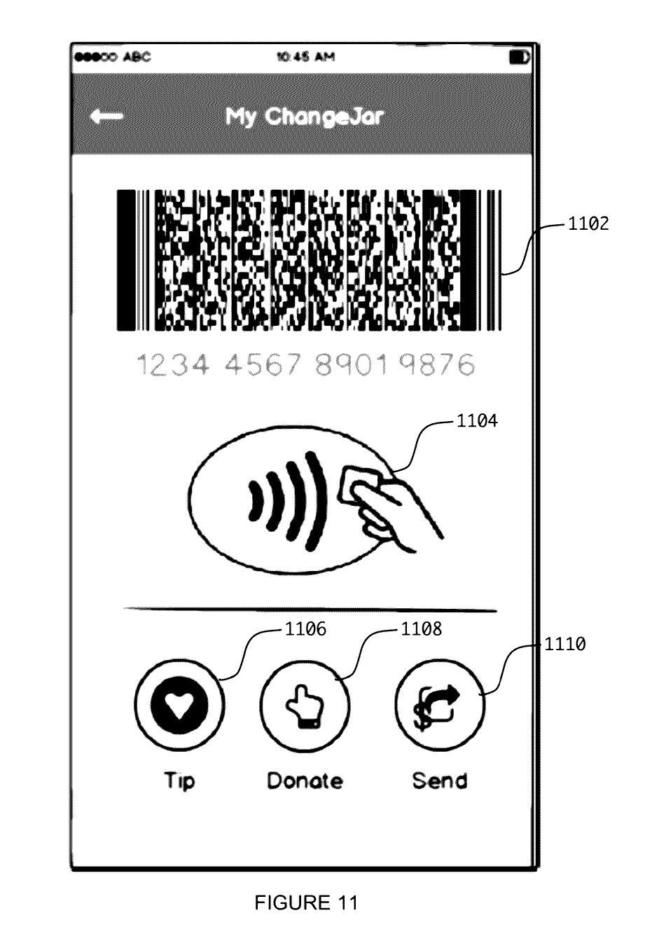

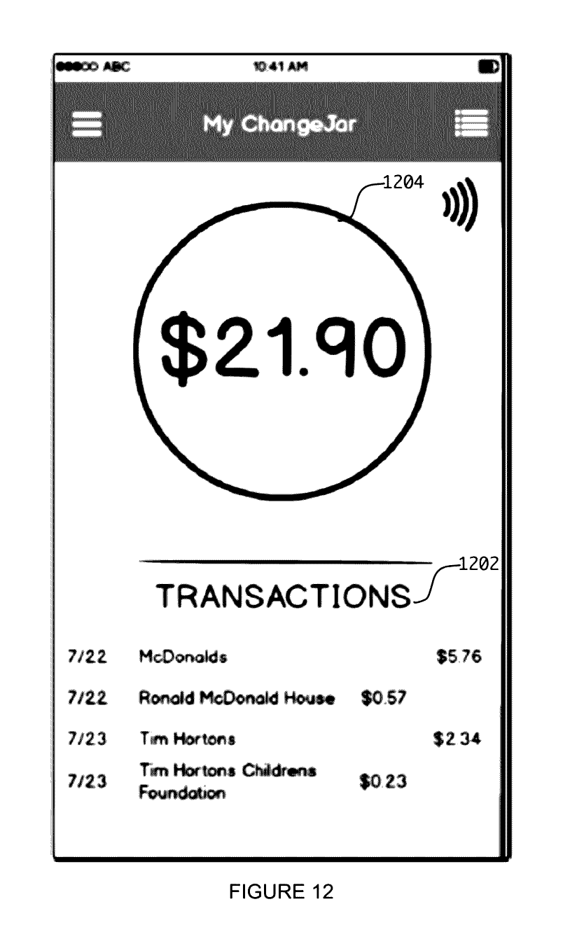

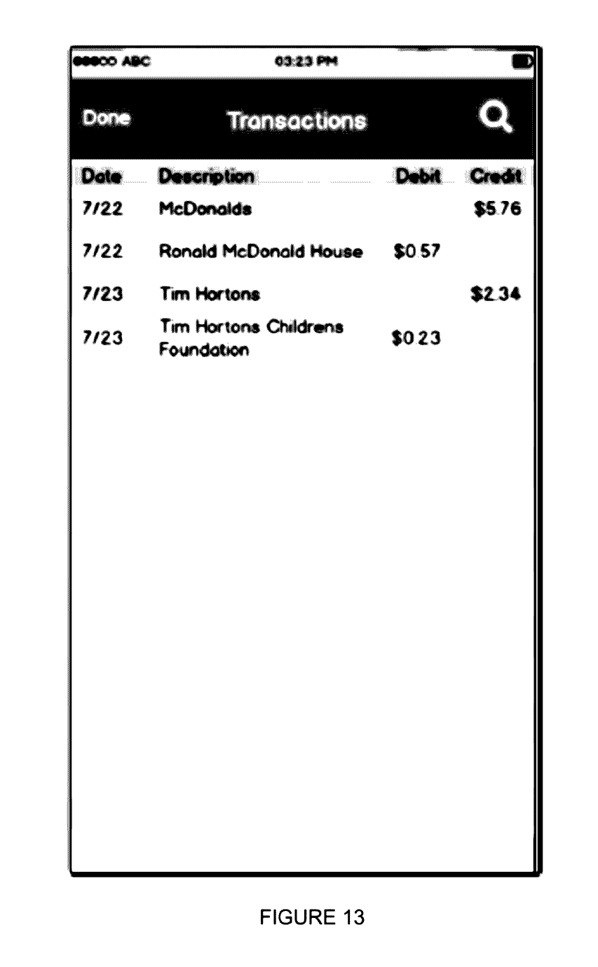

With added reference to FIG. 11, a change management page for executing a cash change capture is activated by tapping an available balance display of the GUI (or the zero-balance display in a first use), and is shown to include a scancode 1102 representative of the decrypted single-use user token to be scanned by the POS terminal and relayed to the server in executing the change capture. An NFC logo 1104 is also depicted identifying NFC as an alternative option to the user in relaying the user token. Once the transaction has been processed, the application is updated by the server and a current balance and recent transaction history listing can be updated, as shown illustratively in FIG. 12. Upon tapping the recent transaction listing 1202, an expanded and searchable listing may be accessed, for example as shown in FIG. 13. As noted above, upon tapping the updated balance display 1204, another transaction can be executed, or again related change management functions accessed, as will be discussed in greater detail below.

Turning back to FIG. 6, one or more sharing options may also be triggered (628) by completion of the cash change processing transaction. While these sharing options may be triggered and relayed concurrently with the transaction update push notification, this step is illustrated separately for clarity. In this example, sharing option details are relayed to the mobile device application (e.g. in the context of a same or distinct push notification) along with a sharing token (S). As sharing accounts and token are configured to receive funds only, single-use sharing tokens are not required and multiple-use tokens are thus used instead for simplicity. Upon receipt of the sharing option details, a corresponding notification or selectable option is generated via the application GUI providing one or more selectable sharing options associated with the recent transaction. As multiple past transactions are logged and made available to the user via a transaction history, sharing options associated with past transactions may also optionally be accessed, in some examples within a given time delay. Once a sharing option has been selected, a fresh user token is decrypted to authorize the transaction, and relayed along with the sharing token and identification of a sharing amount to be processed. Upon receipt of the sharing request (634), the server verifies the user's available balance (change jar), and debits the user's available balance and credits the selected sharing account by the sharing amount identified (636). The sharing transaction is confirmed to the application along with the issuance of a fresh user token, which is stored encrypted, as usual (638).

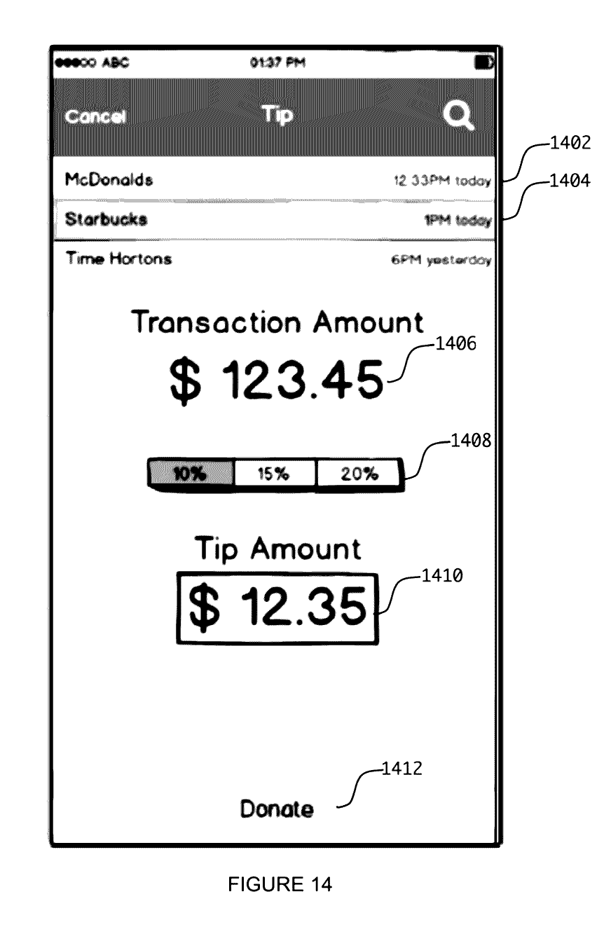

With added reference again to FIG. 11, the mobile transaction management page shown in this figure further includes a set of sharing functions, illustrated herein as a tipping function initiated by tap-activated button tip button 1106, and a donation function initiated by a tap-activated donate button 1108. In the illustrated example, upon tapping the tip button 1106, the application turns to an interactive tipping interface, shown at FIG. 14. A selectable and searchable list of recent transactions 1402 is provided, showing in this case three recent transactions within the last 24 hours, with a given transaction 1404 currently selected for tip processing. In response to the transaction selection, a transaction amount 1406 is displayed, along with preset tipping percentage buttons 1408. In the illustrated example, a 10% tip is selected for a $123.45 transaction, resulting in a $12.35 being proposed in the tip amount window 1410. Once approved, the user simply taps the “Donate” button 1412, and the transaction is processed as described above, each identified tip-able transaction having associated therewith a corresponding sharing token stored by the application.

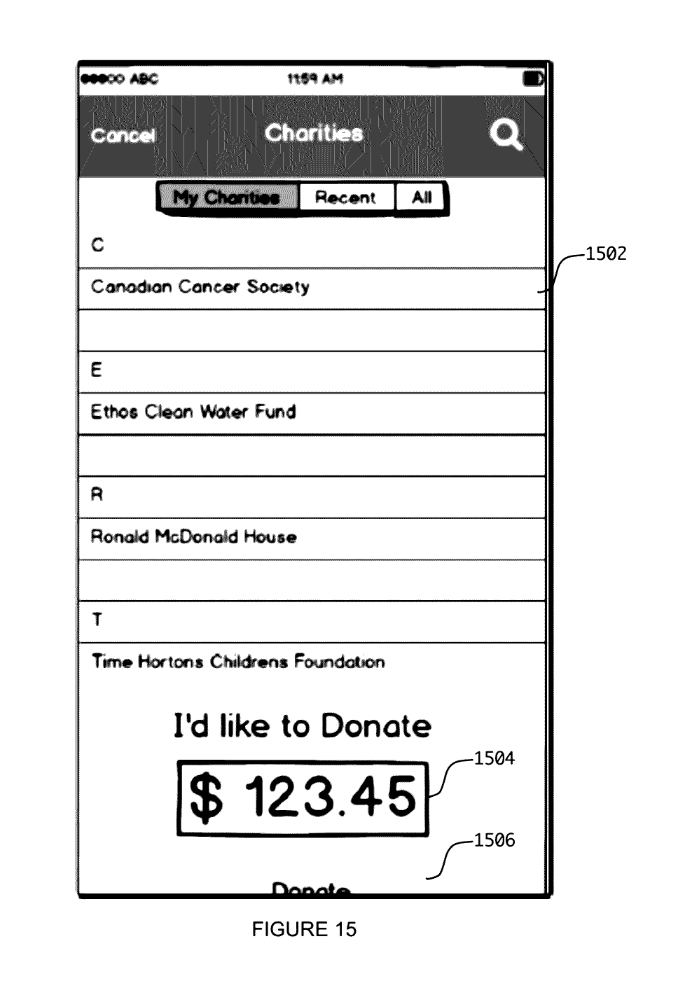

Upon tapping the donate button 1108, the application turns to an interactive charities interface, shown at FIG. 15. A selectable and searchable list of available charities 1502 is provided, showing in this case four selectable charities associated with previous transactions and listed under a “My Charities” tab. “Recent” and “All” charities tabs are also provided to facilitate identification of a charity of interest. In this case, a data entry donation box 1504 is rendered for input of a desired sharing amount. Once entered, the user again simply taps the “Donate” button 1506, and the transaction is processed as described above, each identified charity having associated therewith a corresponding sharing token stored by the application.

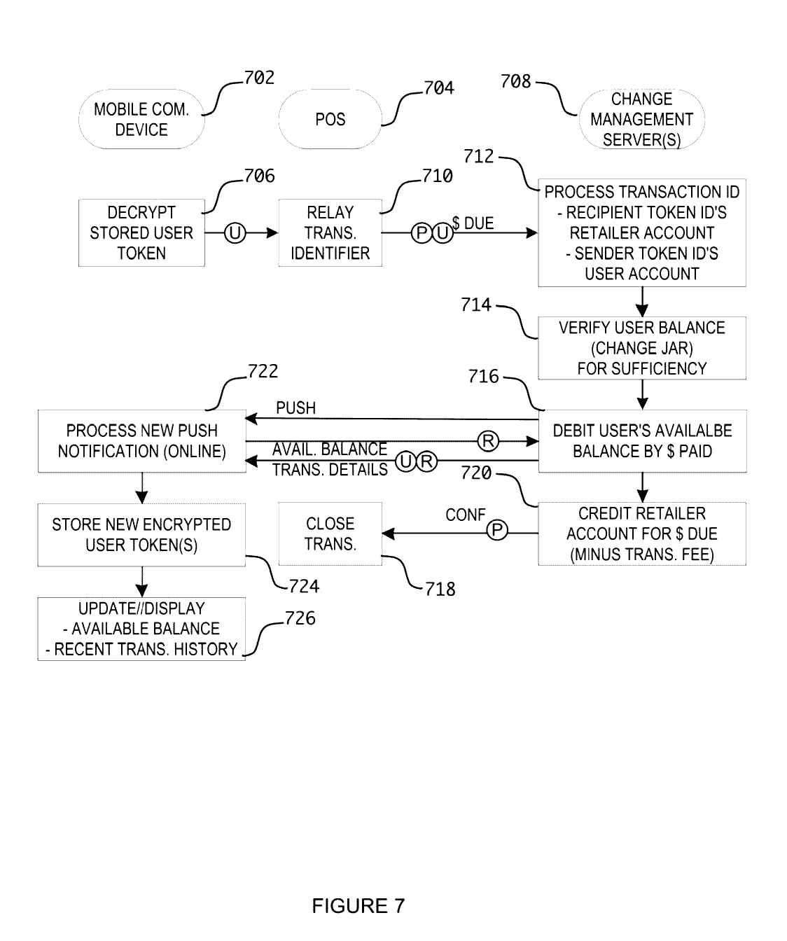

With reference now to FIG. 7, a mobile payment process will now be described within the context of the mobile application processes described above with reference to FIGS. 5 and 6. Much like the change capture process of FIG. 6, if the user elects to execute a mobile payment via its mobile device 702 at a given POS 704, the user will activate their mobile application to decrypt one of their stored user tokens (706) via the client AES key, and invoke communication of a cash payment identifier including this user token to the server 708. In this example, the decrypted user token (in this case the sender token) is first relayed to the POS terminal 704 (e.g. via NFC or a POS scannable code at 710), which then relays the decrypted user token, along with a POS-identifying (recipient) token (P) and a cash payment amount due to the retailer, to the server 708. Other transaction details and related metadata of potential interest to the merchant, user or related parties in downstream analytics may also be relayed, as noted above. It will be noted that the mobile device 702 may again be operated offline and still invoke the electronic cash payment function.

Upon receipt of the transaction identifier at the transaction server, the user account is identified from the sender token, and the retailer account is identified from the recipient token (712). The server verifies a sender balance (virtual change jar of the user) for sufficiency of funds (714) before debiting the user's available balance for the payment amount due (716). Concurrently, the merchant's account will be credited by the payment amount, optionally minus a transaction fee (720). A confirmation is optionally sent to the POS 704 along with a fresh POS-identifying token, and the transaction is closed (718). The server 708 will also issue a push notification to the client to be processed at 722. If the mobile device is currently offline, the push notification will be received upon regaining network access. In this example, the push notification triggers the transfer of details pertaining to the recent payment transaction (e.g. transaction amount), an available balance update (726), and the issuance of one or more fresh user tokens to replace the one(s) used in recent transactions, for example the one or more user tokens used while the application was operated offline. These replaced tokens are again stored encrypted (724) on the mobile device 702. Similar sharing functions and features may be applied in respect of a purchase transaction as were described above in respect of a cash change capture transaction. For example, tipping or donation sharing options may again be relayed to the mobile application from the server for execution in respect of recent mobile payment transactions, and that, even in the absence of a cash change return transaction which does not come into play within the context of a purely mobile payment transaction. Regardless, such sharing options would, in the context of a cash change management application, invoke the processing of an accumulated cash change balance available after execution of the mobile payment transaction, though other embodiments may rather contemplate execution of mobile payment transactions from another user financial account or the like not limited to an accumulated cash change balance.

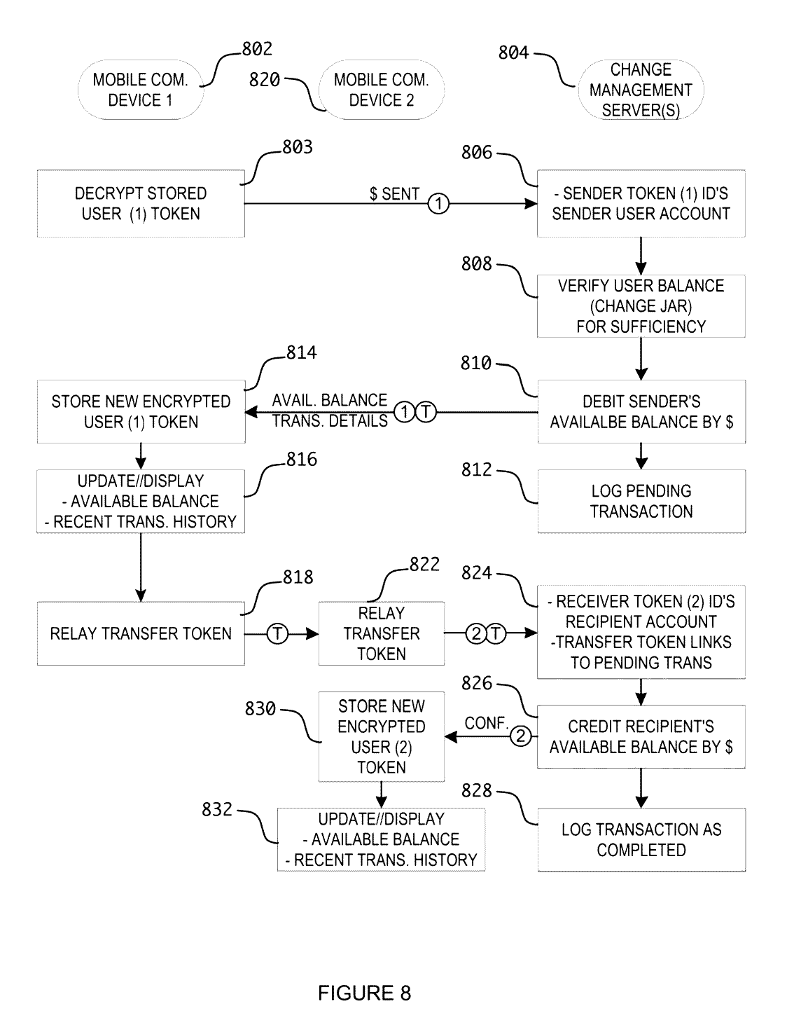

With reference now to FIG. 8, a peer-to-peer cash change transfer process will now be described. Much like the change capture and payment transactions noted above, peer-to-peer transactions may be executed using embodiments of the mobile application described herein via similar token-mediated transactions. In its most straightforward implementation (not shown in FIG. 8), a sending application may act more or less as a POS terminal within the context of a change capture process, whereby the sending application may access a recipient token from a recipient application (e.g. NFC, scancode, etc.) and relay this recipient token along with one of its own sender tokens and an amount to be sent to the recipient to the server for processing much as it would process an electronic cash change transaction.

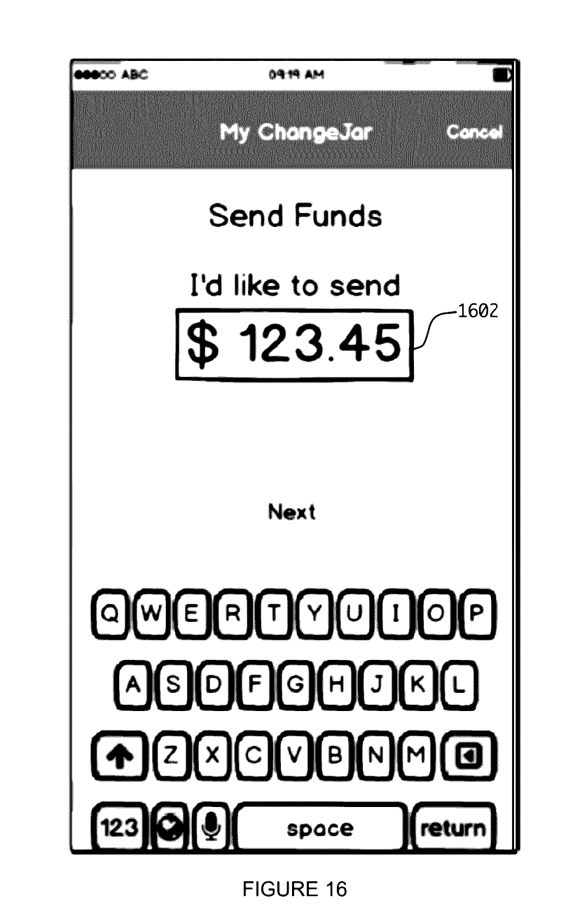

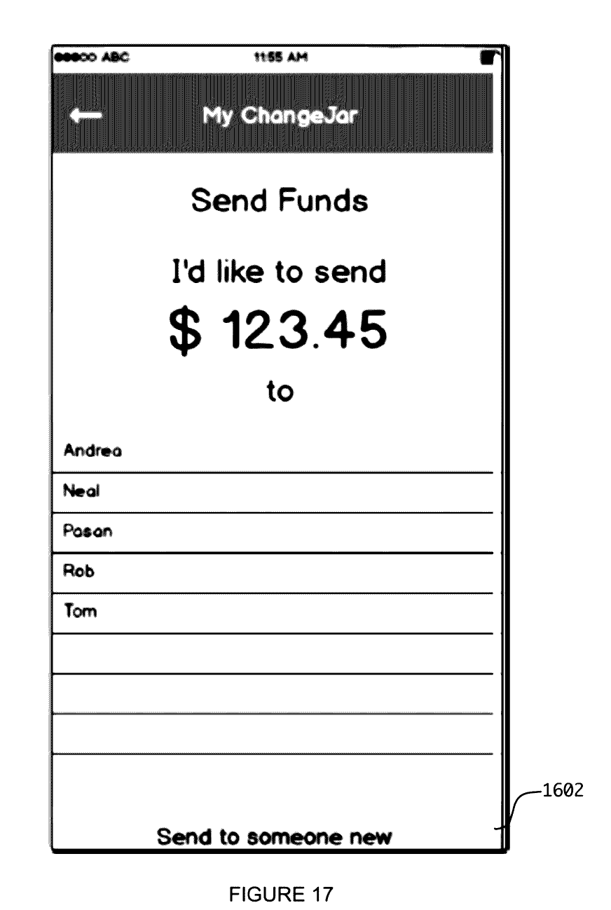

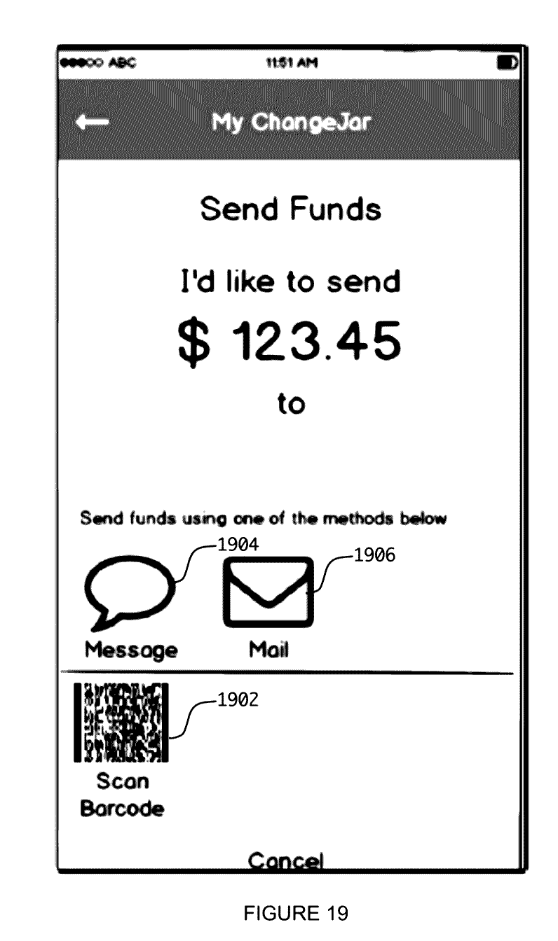

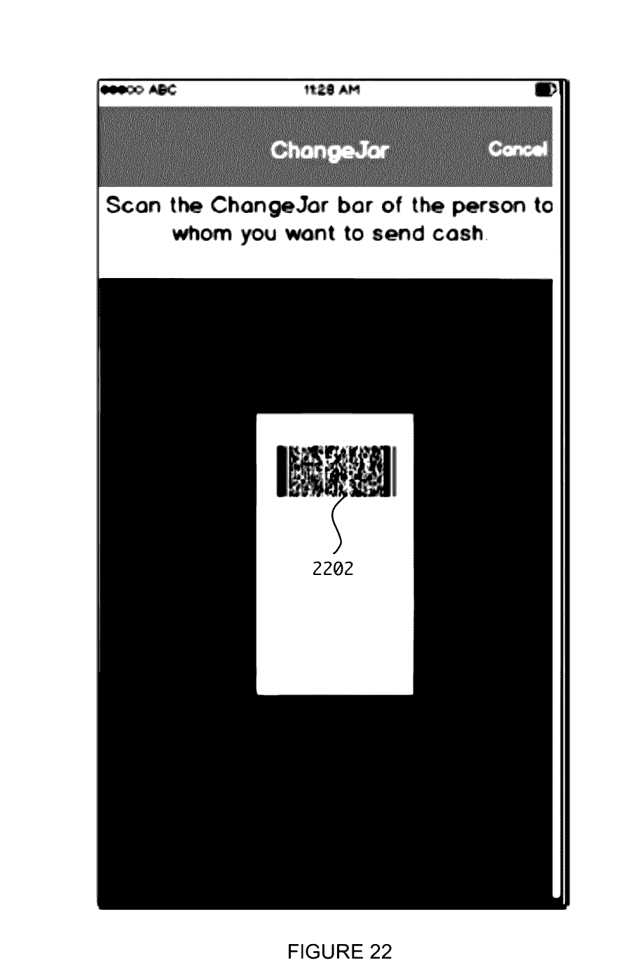

Following from the example of FIG. 11, a send button 1110 may be selected to redirect the user to a sequence of peer-to-peer funds transfer interfaces, as shown for example at FIGS. 16 to 22. In the above scenario, the user would enter an amount to be sent (i.e. to be transferred from their available balance to the recipient's available balance) in the field entry box 1602 of FIG. 16, and then proceed to select to select the “Send to someone new” option 1702 shown at FIG. 17. This would lead to the interface of FIG. 19, where the “scan barcode” option 1902 could be selected. This selection would then automatically activate a mobile camera-mediated interface (see FIG. 22) for the capture of a corresponding recipient token image (i.e. as displayed as a scancode 2202 on the recipient's phone as viewed by the sender's phone camera), the capture of which would automatically execute the transfer much as described above with reference to FIG. 6, replacing reference to the POS with reference to the sending party's mobile device.

Turning back to FIG. 8, a peer-to-peer transfer may otherwise be executed between peers without either party having ready access to the other's client tokens. In the illustrated example, a first (sender) mobile device 802 and application will initiate the process by decrypting (803) one of their own user tokens (1) and relaying it to the server 804 along with an amount to be sent to the recipient. At the server 804, the sender token identifies the sender's user account to be debited (806), which is verified for sufficiency of funds to execute the transaction (808), and ultimately debited the selected amount (810). The transaction is logged as a pending transaction at the server (812) and a pending transaction token (T) and fresh user token (1) are sent back to the sending device 802 along with an updated available balance and transaction details. The sending device stores the fresh user token (814), updates its available balance and transaction history (816), and relays (818) the pending transaction token (T) to the second (recipient) mobile device 820 via e-mail, SMS, messenger or other available communication means (e.g. in the form of a hyperlink or the like).

The recipient application itself relays the pending transaction token (T) to the server (822) along with one of its own user token (2), the former being used by the server to relocate the pending transaction from the log whereas the latter is used to identify the recipient account (824). The recipient's available balance is then credited by the transferred amount (826) and the transaction is logged as completed (828). Meanwhile, a transfer confirmation is returned to the recipient's mobile device along with a fresh user token (830), and an available balance and transaction history update (832).

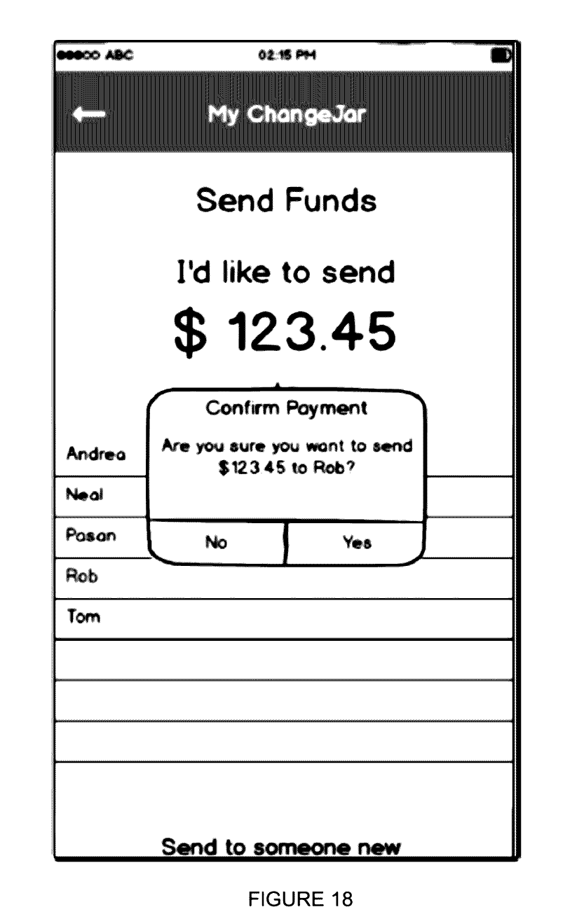

Following from the example of FIGS. 11 and 16 to 22, and in the above scenario, upon tapping the send button 1110, the user would be invited to enter an amount to be sent (i.e. to be transferred from their available balance to the recipient's available balance) in the field entry box 1602 of FIG. 16, and then proceed to select to the interface of FIG. 17. Upon selecting a known contact from the listed contacts (e.g. “Rob”), the user is presented with a confirmation window, as shown for example at FIG. 18. The process described above would then proceed on the basis of a preferred contact medium for the selected contact, which would be used to direct the pending transfer token to the recipient for processing at their end.

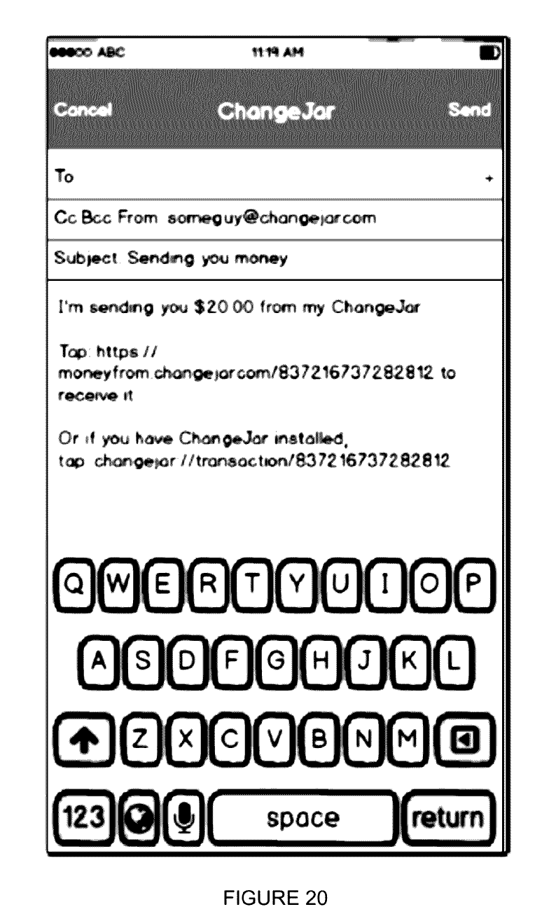

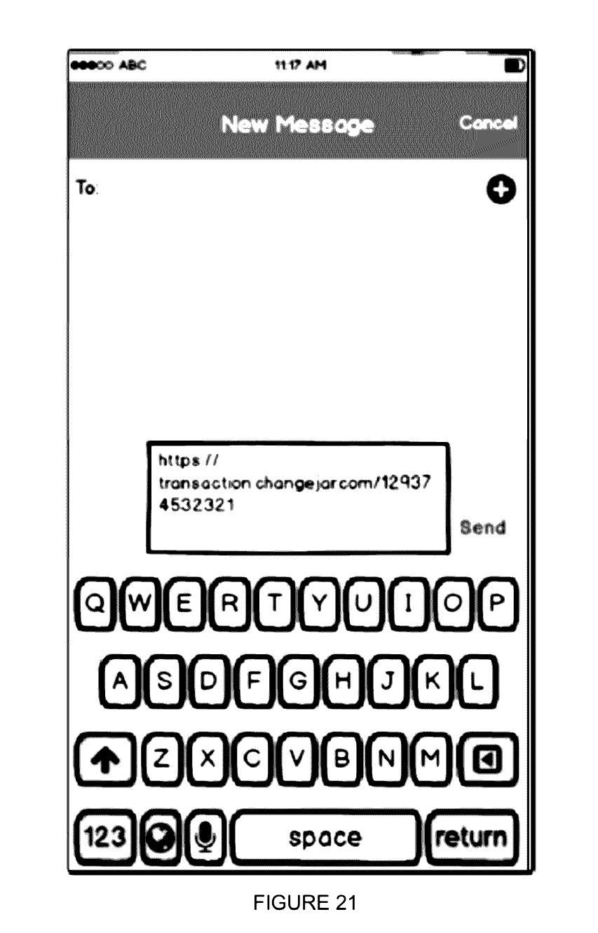

Upon selecting the “Send to someone new” option 1702, however, the user would again be lead to the interface of FIG. 19, where one of message 1904 and email 1906 transfer options can be selected, the former leading to the messaging (e.g. SMS) interface of FIG. 21, the latter leading to the email interface of FIG. 20, for example.

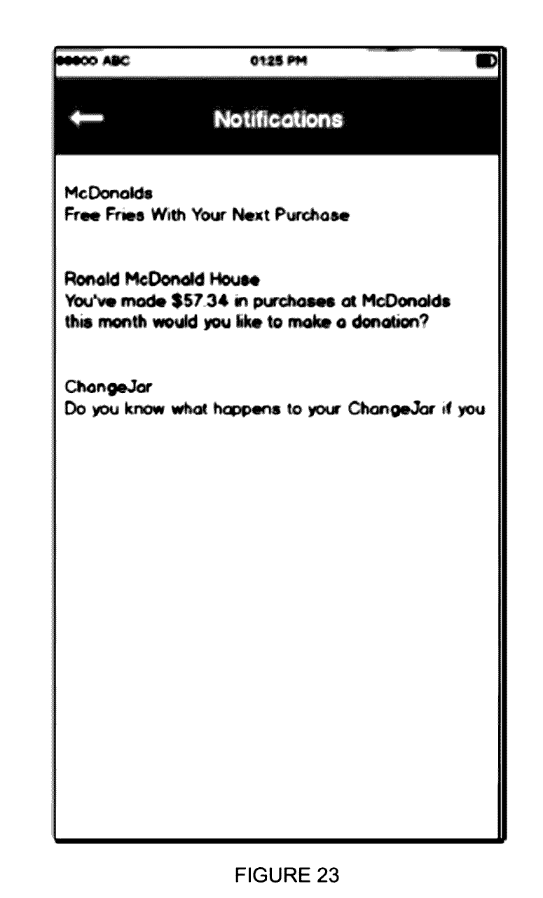

FIG. 23 shows a notifications page listing push notifications received by the application and selectable in providing additional information, rewards and direct access to selected change management and sharing functions, in accordance with some embodiments.

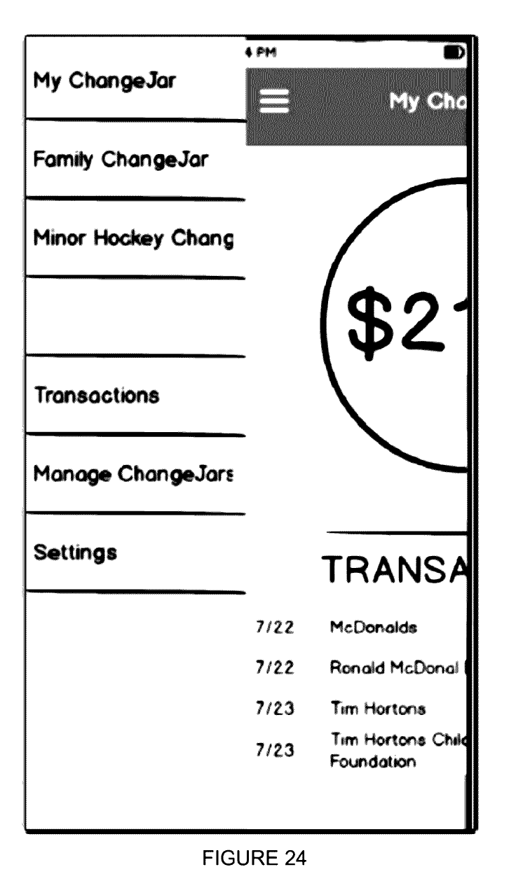

FIG. 24 shows a slide-out utility menu accessible to toggle between user accounts, settings, preferences and logs, for example.

While the present disclosure describes various exemplary embodiments, the disclosure is not so limited. To the contrary, the disclosure is intended to cover various modifications and equivalent arrangements included within the general scope of the present disclosure.

What is claimed is:

1. A mobile cash change processing system for processing cash change to be returned to a user in return for a cash payment transaction executed by this user at a given retailer location, the system comprising:
a monetary transaction server remotely operable to execute electronic monetary transactions between digitally stored accounts, said server having stored in association therewith:
user account data associated with each of a plurality of registered user accounts;
retailer account data associated with each of a plurality of registered retailer accounts; and
sharing account data associated with each of a plurality of registered sharing accounts, wherein each of said sharing accounts is directly or indirectly associated with a respective retailer account;
a digital mobile application operable on the user's mobile device to:
invoke communication of a cash change return identifier associated with the cash payment transaction to said server, wherein said return identifier digitally identifies a cash change amount, a given user account associated with the user and a given retailer account associated with the cash payment transaction at the given retailer location, and wherein receipt of said communication by said server results in an increase to an available sharing balance associated with said given user account corresponding to said cash change amount to be debited from said given retailer account;
receive identification of a given sharing account associated with the given retailer location;
display a selectable sharing option to the given user via a graphical user interface of said mobile device in which information pertaining to said given sharing account is visibly rendered for the given user, wherein selection of said sharing option authorizes a monetary sharing amount to be transferred to said given sharing account from said available sharing balance; and
communicate user selection of said sharing option to said transaction server in response to said user selection so to invoke an electronic transfer of funds corresponding to said sharing amount from said available sharing balance to said sharing account.

2. The system of claim 1, wherein said mobile application is further operable to receive at least part of said cash change return identifier from a POS terminal associated with the cash payment transaction that digitally identifies said cash change amount and said retailer account, and directly communicate said cash change return identifier to said server for processing.

3. The system of claim 1, wherein said mobile application is further operable to make accessible to a POS terminal a user account identifier to be relayed by said POS terminal to said server along with identification of said cash change amount and said retailer account, for processing.

4. The system of claim 2, further comprising a POS terminal interface to said server operable on each of a plurality said POS terminal.

5. The system of claim 1, wherein said mobile application is further operable to:
display a selectable cash change processing option to the user comprising at least:
a cash change deposit option in which at least a portion of said cash change amount is to be deposited in said given user account; and
said selectable sharing option in which at least a portion of said cash change amount is to be deposited in said given sharing account;
record user selection of at lest one of said processing options; and
communicate a mobile transaction communication to said transaction server in response to said user selection so to invoke a direct or indirect electronic transfer of funds at least partially corresponding to said cash change return amount from said given retailer account corresponding to a selected one or more of said given user account and said given sharing account;
wherein said transfer of funds is implemented by the server upon receipt of said transaction communication from the user's mobile device.

6. The system of claim 5, wherein said given sharing account comprises a tipping account or a social giving account associated with said given retailer account or a given POS location associated therewith, and wherein said cash change sharing option comprises a selectable sharing amount to be redirected from said cash change return amount to said sharing account upon processing said cash change return amount.

7. The system of claim 1, wherein said cash change amount is first transferred in full from said given retailer account to said given user account in increasing said available balance, and wherein said sharing amount is subsequently transferred from said given user account to said sharing account in response to selection of said sharing option.

8. The system of claim 1, wherein said given sharing account comprises a tipping account or a social giving account associated with said given retailer account or a given POS location associated therewith.

9. The system of claim 1, wherein said user selection of said sharing option is processed anonymously between said mobile application and said transaction server such that a POS location associated with said given retailer account is blind to an originator of said sharing amount.

10. The system of claim 1, wherein said transaction server has further associated therewith a transaction analytics engine that compiles demographics on at least one of tipping amounts, tipping rates and/or tipping frequencies; donation amounts, donation rates, donation types and/or donation frequencies; types of individuals most likely to perform cash transactions; and the like.

11. The system of claim 1, wherein said cash change return identifier further identifies a cash payment amount for said cash payment transaction, and wherein said sharing option includes a selectable sharing amount defined as a function of said cash payment amount.

12. The system of claim 1, wherein said available balance is further increased by an added monetary cash payment incentive amount automatically added to said cash change return amount and debited from said given retailer account.

13. The system of claim 12, wherein said cash change return identifier further identifies a cash payment amount for said cash payment transaction, and wherein said added monetary cash payment incentive is automatically calculated as a function of said cash payment amount.

14. The system of claim 2, wherein said part of said cash change return identifier is received from said POS terminal via a printed scan-code identifier, a manual input identifier or a short-range digital communication identifier output by said POS terminal.

15. The system of claim 3, wherein said user account identifier consists of a randomly generated client token previously associated with said given user account.

16. The system of claim 15, wherein said randomly generated client token consists of a single-use token.

17. The system of claim 16, wherein said server is operable to associate a set of two or more single-use client tokens with said given user account upon initialization thereof, and securely relay said set to said mobile application, each to be used thereby as said user account identifier in sequential transactions, wherein said server regularly updates said set with said mobile application as said single-use tokens are consumed.

18. A computer-readable medium having statements and instructions stored therein to be implemented by a digital processor of a mobile communication device to execute a mobile application on the mobile device in respect of a cash payment transaction executed at a point-of-sale (POS) location to:
invoke communication of a cash change return identifier associated with the cash payment transaction to a transaction server, wherein said return identifier digitally identifies a cash change amount, a given user account associated with the user and a given retailer account associated with the cash payment transaction at the POS location, and wherein receipt of said communication by said server results in an increase to an available sharing balance associated with said given user account corresponding to said cash change amount to be debited from said given retailer account;
receive identification of a given sharing account associated with the POS location;
display a selectable sharing option via a graphical user interface of said mobile device in which information pertaining to said given sharing account is visibly rendered;
record selection of said sharing option as authorization to execute transfer of a monetary sharing amount to said given sharing account from said available sharing balance; and
communicate said selection of said sharing option to said server to invoke an electronic transfer of funds corresponding to said sharing amount from said available sharing balance to said sharing account.

19. The computer-readable medium of claim 18, further comprising statements and instructions to receive at least part of said cash change return identifier from a POS terminal at the POS location that digitally identifies said cash change amount and said retailer account, and directly communicate said cash change return identifier to said server for processing.

20. The computer-readable medium of claim 18, further comprising statements and instructions to make accessible to a POS terminal at the POS location a user account identifier to be relayed by said POS terminal to said server along with identification of said cash change amount and said retailer account, for processing.
